(19) United States
(12) Patent Application Publication
(10) Pub. No.: US 2019/0086223 A1
(43) Pub. Date: Mar. 21, 2019

(54) INFORMATION PROCESSING DEVICE, INFORMATION PROCESSING METHOD, AND MOBILE DEVICE

(71) Applicant: SONY CORPORATION, TOKYO (JP)

(72) Inventors: SHO TANAKA, TOKYO (JP); TAKUMI HACHISUKA, TOKYO (JP); HIROSHI UJI, CHIBA (JP); KENICHI MATSUHISA, TOKYO (JP); KAZUMA YOSHII, TOKYO (JP)

(21) Appl. No.: 16/077,795

(22) PCT Filed: Feb. 15, 2017
(86) PCT No.: PCT/JP2017/005454

§ 371 Date: Aug. 14, 2018

(30) Foreign Application Priority Data
Apr. 14, 2016 (JP) 2016-080978

(51) Int. Cl. G01C 21/34; G08G 1/0968

(52) U.S. Cl. CPC G01C 21/3476; G08G 1/096872; G08G 1/096866

(57) ABSTRACT

A mobile device 20 transmits, to an information processing device 50, a route search request including search conditions which contain a destination, destination arrival time, and moving purpose designated by a user. On the basis of the route search request, the information processing device 50 searches for a moving route to the destination in accordance with the destination arrival time, together with stop-by place candidates corresponding to the moving purpose, and transmits a search result to the mobile device 20. The mobile device 20 presents the searched moving route to the user. Moreover, in response to selection of a stop-by place by the user, the moving route, an estimated arrival time to the destination, and the stop-by place candidates are dynamically changed. A moving plan which includes information regarding available stop-by places can be provided from a mobile device of a vehicle or the like.

### TECHNICAL FIELD

This technology relates to an information processing device, an information processing method, and a mobile device, each processing information provided by a mobile device of a vehicle, a terminal device or others.

### BACKGROUND ART

A navigation device mounted on an automobile or other types of vehicle searches a route to a set destination on the basis of a position of the self-vehicle and map data, and provides route guidance by using images and voices to a user such as a driver. Furthermore, according to Patent Document 1, in a case where a stop-by place category is set by the user, facilities corresponding to the set category and respectively located within a predetermined range from a plurality of destinations are detected. Moreover, with arrival of the vehicle at a predetermined position from one of the destinations, the detected facility located between the plurality of destinations is automatically displayed.

### CITATION LIST

### Patent Document

### Patent Document 1: Japanese Patent Application Laid-Open No. 2014-238290

### SUMMARY OF THE INVENTION

### Problems to be Solved by the Invention

Incidentally, in the case where the facility located between the plurality of destinations is displayed after arrival of the vehicle at the predetermined position, an arrival time at each of the destinations changes after use of the displayed facility. Therefore, in a case where arrival at each of the destinations at a desired time is intended, it is difficult to determine whether use of the displayed stop-by place is allowable.

Accordingly, it is an object of this technology to provide an information processing device, an information processing method, and a mobile device, each performing a process for providing a moving plan, including information regarding available stop-by places from a mobile device of a vehicle or the like.

### Solutions to Problems

A first aspect of the technology disclosed in the present specification is directed to an information processing device including:

an acquisition unit that acquires a predetermined condition input by a user; and

a route search unit that acquires a moving plan including a via-point and a destination, and stop-by place candidates based on the moving plan on the basis of a moving plan search request including the predetermined condition acquired by the acquisition unit, and outputs the moving plan and the stop-by place candidates,

in which the moving plan is a plan considering a time consumed by the user at least at the via-point.

According to a second aspect of the technology disclosed in the present specification, in the information processing device according to the first aspect, the predetermined condition is configured to be selected from any one of items concerning the user, i.e., a moving purpose, preference, gender, age, number of using persons, use time zone, destination, budget, and date and time by which arrival at the destination is necessary.

According to a third aspect of the technology disclosed in the present specification, in the information processing device according to the first aspect, the moving plan is information regarding a route along which a moving body travels, and a date and time on which the moving body travels.

According to a fourth aspect of the technology disclosed in the present specification, in the information processing device according to the third aspect, the route search unit is configured to acquire stop-by information regarding actual traveling of the moving body, and update the stop-by place candidates on the basis of the acquired stop-by information.

According to a fifth aspect of the technology disclosed in the present specification, in the information processing device according to the third aspect, the moving plan search request includes information indicating a situation in the moving body. The route search unit is configured to select the stop-by place candidates on the basis of the acquired information indicating the situation in the moving body.

According to a sixth aspect of the technology disclosed in the present specification, in the information processing device according to the first aspect, the route search unit is configured to acquire related person information indicating a person related to the user, and set the stop-by place candidates on the basis of the related person information.

According to a seventh aspect of the technology disclosed in the present specification, in the information processing device according to the first aspect, the route search unit is configured to display, together with the moving plan, the stop-by place candidates as positions in a stop-by order of the via-point and the destination in the moving plan.

According to an eighth aspect of the technology disclosed in the present specification, in the information processing device according to the first aspect, the route search unit is configured to acquire the moving plan that passes through the stop-by place candidates in a descending order of priority on the basis of priority set in advance for each of the stop-by place candidates.

According to a ninth aspect of the technology disclosed in the present specification, in the information processing device according to the first aspect, the route search unit is configured to also output a reason for recommending each of the stop-by place candidates.

According to a tenth aspect of the technology disclosed in the present specification, in the information processing device according to the first aspect, the moving plan search request includes reproduced music information indicating music being reproduced in a moving body boarded by the user that uses the moving plan acquired by the route search unit. The route search unit is configured to select the stop-by place candidates on the basis of the reproduced music information.

According to an eleventh aspect of the technology disclosed in the present specification, in the information processing device according to the first aspect, the route search unit is configured to perform control to display the moving plan and the stop-by place candidates on a display unit. Display of the moving plan is controlled such that information regarding the via-point and the destination is configured to be displayed in time series in accordance with an estimated arrival time of each of the via-point and the destination, and that a time consumed by the user at least at the via-point is also displayed.

According to a twelfth aspect of the technology disclosed in the present specification, in the information processing device according to the first aspect, the route search unit is configured to perform moving plan search using information that indicates a time consumed by the user at each of the stop-by place candidates and is acquired on the basis of the stop-by place candidates to acquire the moving plan.

According to a thirteenth aspect of the technology disclosed in the present specification, in the information processing device according to the first aspect, the route search unit is configured to acquire the moving plan that passes near a predetermined facility for each predetermined moving distance.

According to a fourteenth aspect of the technology disclosed in the present specification, in the information processing device according to the first aspect, the route search unit is configured to acquire the moving plan by search of the moving plan in consideration of congestion state of each of the stop-by place candidates.

According to a fifteenth aspect of the technology disclosed in the present specification, in the information processing device according to the first aspect, the moving plan search request includes information indicating a situation in a moving body boarded by the user that uses the moving plan acquired by the route search unit. The route search unit is configured to change the moving plan on the basis of the acquired information indicating the situation in the moving body.

According to a sixteenth aspect of the technology disclosed in the present specification, in the information processing device according to the first aspect, the moving plan search request includes service information possessed by the user that uses the moving plan acquired by the route search unit. In the route search unit, a stop-by place for which the service information is available is included in the stop-by place candidate.

According to a seventeenth aspect of the technology disclosed in the present specification, in the information processing device according to the first aspect, a storage unit that stores the moving plan in a reusable manner is further provided. The route search unit is configured to enable the user that uses the moving plan acquired by the route search unit to use the moving plan recorded in the storage unit.

In addition, an eighteenth aspect of the technology disclosed in the present specification is directed to an information processing method including:

acquiring, by using an acquisition unit, a predetermined condition input by a user; and

acquiring, by using a route search unit, a moving plan that includes a via-point and a destination, and considers a time consumed by the user at least at the via-point on the basis of a moving plan search request including the predetermined condition acquired by the acquisition unit, and stop-by place candidates based on the moving plan, and outputting the moving plan and the stop-by place candidates.

Furthermore, according to a nineteenth aspect of the technology disclosed in the present specification is directed to a mobile device including:

a communication unit that transmits a moving plan search request including a predetermined condition input by a user to an information processing device, and receives a moving plan including a via-point and a destination acquired by the information processing device in response to transmission of the moving plan search request, and stop-by place candidates based on the moving plan;

an input unit through which the predetermined condition is input; and

an information presenting unit that presents the moving plan and the stop-by place candidates received by the communication unit.

Furthermore, according to a twentieth aspect of the technology disclosed in the present specification, in the mobile device according to the nineteenth aspect, the input unit includes a voice input unit. The information presenting unit includes a display unit or a voice output unit. A control unit is further provided to cause the input unit and the information presenting unit to select a stop-by place from the stop-by place candidates, change the selected stop-by place, or change the moving plan in an interactive manner.

### Effects of the Invention

According to this technology, a moving plan including a via-point and a destination, and stop-by place candidates based on the moving plan are acquired by a route search unit on the basis of a moving plan search request which includes a predetermined condition inputted by a user and acquired by an acquisition unit. Furthermore, the moving plan is a plan considering a time consumed by the user at least at the via-point. Accordingly, an information processing device, an information processing method, and a mobile device each performing a process for providing the moving plan and the stop-by place candidates from a mobile device of a vehicle or the like can be provided. Note that advantageous effects described in the present specification are presented only by way of example, and additional advantageous effects may be offered.

### BRIEF DESCRIPTION OF DRAWINGS

FIG. 1 is a diagram illustrating an example of a configuration of an information providing system.

FIG. 2 is a diagram illustrating an example of a function configuration of a mobile device.

FIG. 3 is a diagram illustrating an example of a function configuration of an information processing device.

FIG. 4 is a sequence diagram illustrating an example of an operation of the information providing system.

FIG. 5 is a flowchart showing a basic processing procedure for presenting information to a user.

FIG. 6 is a diagram illustrating a configuration example of a graphical user interface (GUI) screen of an initial menu.

FIG. 7 is a diagram illustrating a configuration example of a GUI screen for presenting, on the mobile device, a moving route and stop-by place candidates available in the moving route.

FIG. 8 is a diagram illustrating an example of a GUI screen whose display has been updated in response to selection (temporary setting) of a stop-by place from stop-by place candidates.

FIG. 9 is a diagram illustrating an example of a GUI screen updated from the GUI screen in FIG. 8 in response to decision of selection (temporary setting) of a stop-by place.

FIG. 10 is a diagram illustrating an example of a GUI screen updated from the GUI screen in FIG. 9 in response to selection (temporary setting) of a cell of a commodity of a stop-by place such as a commercial facility.

FIG. 11 is a diagram illustrating an example of a GUI screen updated from the GUI screen in FIG. 10 in response to decision of a new stop-by place.

FIG. 12 is a diagram illustrating an example of a GUI screen updated from the GUI screen in FIG. 8 in response to decision of a commodity or service to be used at a commercial facility for which stopping-by has been decided.

FIG. 13 is a flowchart showing a processing procedure for displaying, on a GUI screen, a commodity or service providable from a stop-by place in a moving route, for example.

FIG. 14 is a flowchart showing another basic processing procedure for presenting information to the user.

FIG. 15 illustrates a configuration example of a GUI screen of an initial menu.

FIG. 16 is a diagram illustrating another configuration example of a GUI screen for presenting, on the mobile device, a moving route and stop-by place candidates available in the moving route.

FIG. 17 illustrates a further configuration example of a GUI screen for presenting, on the mobile device, a moving route and stop-by place candidates available in the moving route.

FIG. 18 is a diagram illustrating an example of a GUI screen whose display has been updated in response to selection (temporary setting) of a stop-by place from stop-by place candidates.

FIG. 19 is a diagram illustrating an example of a GUI screen in a case where a “store BBB” has been decided as a stop-by place.

FIG. 20 is a flowchart showing a processing procedure performed in case of presentation of stop-by place candidates or a route change in accordance with a state inside a vehicle.

### MODE FOR CARRYING OUT THE INVENTION

An embodiment according to the technology disclosed in the present specification is hereinafter described in detail with reference to the drawings. Note that the description is presented in the following order.

1. Overall Configuration of Information Providing System

2. Configurations of Mobile Device and Information Processing Device

3. Operation of Information Providing System

<1. Overall Configuration of Information Providing System>

According to this technology, a moving plan search request which includes predetermined conditions, such as search conditions indicating a destination and a date and time by which arrival at the destination is necessary (destination arrival time), and a moving purpose, is acquired from a mobile device. A moving plan until the destination in accordance with the destination arrival time is acquired by an information processing device. Furthermore, the mobile device presents the moving plan acquired by the information processing device to a user of the mobile device. It is also assumed that the moving plan is a plan considering a time consumed by the user at least at a via-point. The mobile device and the information processing device may be integrated or separately provided. Note that described hereinafter is a case where the mobile device and the information processing device are separately provided, and connected to each other via a communication path.

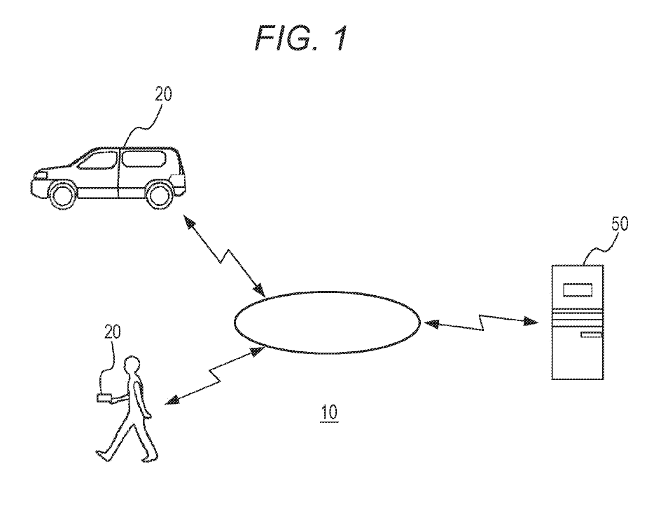

FIG. 1 illustrates an example of a configuration of an information providing system. An information providing system 10 includes a mobile device 20 and an information processing device 50. The mobile device 20 may be integrated with a vehicle (or incorporated in vehicle), or configured as a device physically independent from a vehicle. In a case where the mobile device 20 is an information terminal device allowed to be carried by the user (user of moving plan), for example, information transmitted from the information processing device 50 is available even while the user is out of the vehicle. Furthermore, the mobile device may be configured such that a part of functional modules of the mobile device also functions as a device incorporated in the vehicle.

The mobile device 20 transmits a moving plan search request (hereinafter referred to as “route search request”) including predetermined conditions to the information processing device 50, receives a moving plan (hereinafter referred to as “moving route”) searched by the information processing device 50 in response to transmission of the route search request, and presents the moving route to the user of the mobile device 20. The predetermined conditions include any of items concerning the user, i.e., a moving purpose, preference, gender, age, number of using persons, use time zone, destination, budget, destination arrival time, and others.

On the basis of the route search request from the mobile device 20, the information processing device 50 searches for a moving route to a destination in accordance with a destination arrival time, together with available stop-by place candidates corresponding to a moving purpose. Furthermore, the moving route is information including information regarding not only a route to a destination but also a date and time. The moving route is searched considering a time consumed by the user at least at a via-point. The information processing device 50 transmits the acquired moving route to the mobile device 20.

<2. Configurations of Mobile Device and Information Processing Device>

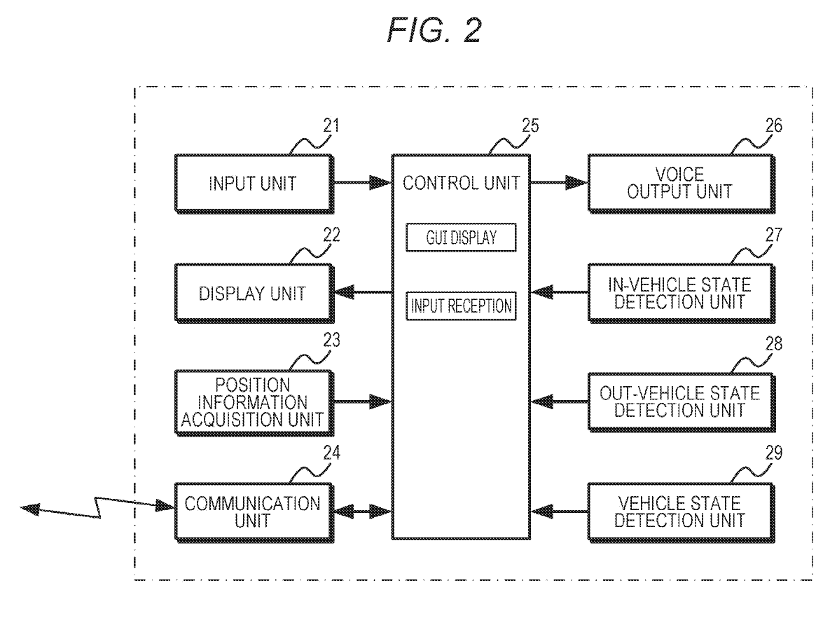

FIG. 2 illustrates an example of a functional configuration of the mobile device according to the present technology. The mobile device 20 includes an input unit 21, a display unit 22, a position information acquisition unit 23, a communication unit 24, and a control unit 25.

The mobile device 20 may be integrated with a vehicle (or incorporated in vehicle), or configured as a device physically independent from a vehicle. For example, the mobile device 20 may also be an information terminal device allowed to be carried by the user. Furthermore, the mobile device 20 may be configured such that a part of functional modules of the mobile device also functions as a device incorporated in the vehicle.

The input unit 21 is a device through which the user inputs to the mobile device 20. The user is allowed to input, via the input unit 21 to the mobile device 20, information used when selecting a moving route and a stop-by place, such information as a destination, destination arrival time, moving purpose, selection of a moving route or course, budget, and the like.

The input unit 21 may have a touch panel and a voice input function, for example. In addition, an information terminal such as a smartphone possessed by the user may also function as the input unit 21. Note that the user referred to herein includes a driver, and an occupant other than the driver. Furthermore, in a case where the vehicle is a car carrying a passenger paying a fare, such as a taxi and a limousine, the user may not include a driver but include only an occupant other than the driver. Note that there is no distinction between a driver and an occupant other than the driver in a vehicle under full-automatic operation.

The display unit 22 displays a graphical user interface (GUI) screen indicating an initial menu, a moving route and the like received by the mobile device 20. Specifically, displayed are a GUI screen of an initial menu for guiding the user about input of a destination, destination arrival time, moving purpose, selection of a moving route or course, budget and the like, a GUI screen showing a search result on the basis of information input by the user via the input unit 21 (described below), and others.

The display unit 22 may include a touch panel integrated with the input unit 21, for example. Alternatively, a device mounted on the vehicle, such as Onbode display, head up display, and car navigation, may be used as the display unit 22, or a screen of an information terminal, such as a smartphone possessed by the user may be utilized as the display unit 22.

The position information acquisition unit 23 acquires information regarding a current location of the vehicle. For example, the position information acquisition unit 23 receives a global navigation satellite system (GNSS) signal (e.g., global positioning system (GPS) signal from GPS satellite) from a GNSS satellite, executes positioning, and generates position information including latitude, longitude, and altitude of the vehicle. Alternatively, the position information acquisition unit 23 may specify a current location on the basis of electric measurement information received from a wireless access point by using PlaceEngine (registered trademark) or the like. Instead, the position information acquisition unit 23 may acquire position information from a positioning unit of the vehicle, or an information terminal such as a smartphone possessed by the user.

For example, the communication unit 24 includes a cellular communication protocol, such as global system of mobile communications (GSM) (registered trademark), worldwide interoperability for microwave access (WiMAX), long term evolution (LTE) or LTE-advanced (LTE-A), a wireless local area network (LAN) such as Wi-Fi (registered trademark), and a general-purpose communication interface such as Bluetooth (registered trademark), to connect to a device (e.g., application server, control server, management server, and the like) present on an external network (e.g., the Internet, cloud network, and unique network of provider). Furthermore, the communication unit 24 connects to a device present on an external network, and exchanges information regarding an available time, congestion state and the like of a stop-by place.

The control unit 25 comprehensively controls overall operations of the mobile device 20. Specifically, the control unit 25 performs processing of a display screen of the display unit 22 based on information input from the user via the input unit 21, processing of graphical user interface (GUI) for facilitating input operation from the user, information communication with an external device via the communication unit 24, and other processing. Moreover, the control unit 25 provides a function known as a recommendation function for urging addition or change of a stop-by place so that the user can dynamically make addition or change of a stop-by place, a change of a moving route, and others in accordance with a recommendation. A voice output unit 26 is further provided. The control unit 25 causes the input unit 21, the display unit 22, and the voice output unit 26 to select a stop-by place from stop-by place candidates, change a selected stop-by place, select or change a moving route in an interactive manner by using displays and voices.

In a case where the mobile device 20 is provided in a vehicle (moving body), the mobile device 20 may further include an in-vehicle state detection unit 27, an out-vehicle information detection unit 28, and a vehicle state detection unit 29.

For example, the in-vehicle state detection unit 27 includes an on-vehicle camera (in-vehicle camera) which captures an image of inside the vehicle, a thermo camera, and a biometric sensor that detects biometric information (e.g., perspiration, body temperature, and heart beat) of the user. The in-vehicle state detection unit 27 may further include a load sensor which detects a load applied to a driver's seat or other seats (e.g., assistant driver's seat and rear seat) (whether or not person is seated on seat), or detects a change in a weight of an interior of the vehicle, a voice sensor such as a microphone, and others.

For example, the presence or absence of the user can be checked on the basis of a recognition result of an image captured by the in-vehicle camera, or a weight change of the seat or the interior of the vehicle detected by the load sensor. Moreover, a vehicle interior situation can be estimated on the basis of a recognition result of an image captured by the in-car camera. Furthermore, in-vehicle information is generated on the basis of a face recognition result of an image captured by the in-vehicle camera, contents of conversation inside the vehicle collected by the voice sensor, a detection result obtained by the biometric sensor, and others.

The control unit 25 can start an information providing process to the interior of the vehicle in response to confirmation of boarding on the basis of a detection result obtained by the in-vehicle state detection unit 27. Furthermore, the control unit 25 may correct stop-by place candidates presented to the user next time on the basis of an in-vehicle situation estimated from a detection result obtained by the in-vehicle state detection unit 27. For example, when some food is not finished yet or left unfinished, a candidate extraction process is performed such that stop-by place candidates presented next time are extracted from stores in groups other than a similar group. In addition, the control unit 25 may sequentially learn a degree of satisfaction of the user estimated from a detection result obtained by the in-vehicle state detection unit 27, and utilize an obtained learning result for a search process for searching a moving route when the same user (or another user) boards the vehicle next time.

For example, the out-vehicle information detection unit 28 includes an environmental sensor for detecting a current weather or atmospheric phenomenon, a surrounding information detection sensor for detecting for example, surrounding vehicles, obstacles, passersby, and accident conditions occurring around the vehicle, and others.

The control unit 25 may appropriately change information to be provided in the interior of the vehicle on the basis of a detection result obtained by the out-vehicle information detection unit 28. This change may be preferable because, for example, the place desired to be stopped by may change depending on a weather or atmospheric phenomenon (e.g., cold food is desired on out-of-season hot day, whereas warm food is desired on out-of-season cold day). Furthermore, it is assumed that the user do not want to stop by, or should not stop by, a place originally desired to be stopped by depending on surrounding circumstances, such as a crowded road state during traveling or occurrence of an accident.

For example, the vehicle state detection unit 29 includes a gyroscope sensor for detecting an angular velocity of shaft rotational motion of a vehicle body, an acceleration sensor for detecting acceleration of the vehicle, sensors for detecting, for example, an operation amount of an accelerator pedal, an operation amount of a brake pedal, a steering angle of a steering wheel, and an engine speed or a rotational speed of a wheel, and others.

The control unit 25 may dynamically change information to be provided in the interior of the vehicle in accordance with a detection result obtained by the vehicle state detection unit 29 (e.g., breakdown of vehicle).

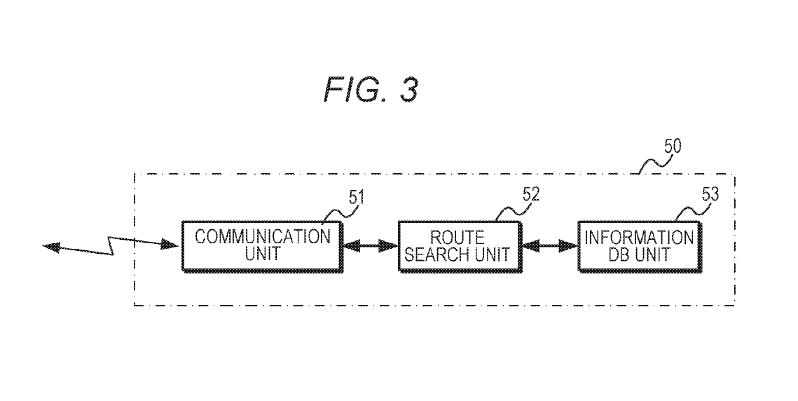

FIG. 3 illustrates an example of a functional configuration of the information processing device. The information processing device 50 includes a communication unit 51, a route search unit 52, and an information database unit 53.

The communication unit 51 communicates with the mobile device 20, and outputs received information, such as a route search request, to the route search unit 52. Furthermore, the communication unit 51 transmits information indicating a moving route searched by the route search unit 52 to the mobile device 20.

On the basis of a route search request issued from the mobile device 20 and including search conditions which contain a destination, destination arrival time, and moving purpose, the route search unit 52 searches for a moving route to the destination corresponding to the destination arrival time. Furthermore, the route search unit 52 searches for a moving route including stop-by place candidates corresponding to the moving purpose on the basis of stop-by place information stored in the information database unit 53.

The information database unit 53 stores stop-by place information. The stop-by place information to be stored includes not only a position and a type of a stop-by place, but also information regarding an available time of a stop-by place, such as business hours and opening hours, estimated congestion time at which a time required for using a stop-by place is expected to increase, and other information. Moreover, the information database unit 53 may store a moving route candidate search result in a reusable manner. Furthermore, the information database unit 53 may store a search result in association with the user or attributes of the user, and reuse a previous search result on the basis of the user or the attributes of the user.

Note that FIG. 3 illustrates an example of the case where the route search unit 52 and the information database unit 53 are integrally provided. However, the route search unit 52 and the information database unit 53 may be provided as independent devices.

<3. Operation of Information Providing System>

The mobile device 20 of the information providing system 10 transmits, to the information processing device 50, a route search request including search conditions which contain a destination, destination arrival time, and moving purpose designated by the user via the input unit 21. On the basis of the route search request, the information processing device 50 selects a moving route to the destination in accordance with the destination arrival time, that is, a moving route for arriving at the destination at the destination arrival time, or within a period from a predetermined time before the destination arrival time to the destination arrival time, together with stop-by place candidates corresponding to the moving purpose. Then, the information processing device 50 transmits a search result, that is, the moving route and the selected stop-by place candidates to the mobile device 20. The mobile device 20 presents the received search result to the user.

Furthermore, the mobile device 20 transmits the in-vehicle state and stop-by information as information contained in the route search request. The stop-by information is information indicating a time required at a stop-by place and the like together with the stop-by place. The information processing device 50 searches for a moving route together with the in-vehicle state and stop-by information, transmits a new moving route to the mobile device 20, and presents the new moving route to the user. The information providing system 10 repeats these processes to dynamically change a moving route.

Note that search and change of a moving route according to the present embodiment include both setting of a via-point, destination, and traveling route of the vehicle in an automatic driving mode, and setting of a via-point, destination, and traveling route on an application for navigation of the vehicle in a manual driving mode.

Examples of a method of presenting information to the user and others are hereinafter listed. Note that information is presented by using the display unit 22 constituting an in-vehicle device, an information terminal device possessed by the user or the like, and in a form of GUI.

(ex.1) Stop-by place candidates extracted in correspondence with a moving route are displayed in time series by GUI.

(ex.2) Estimated required time, and providable commodities and services are presented for each stop-by place candidate by GUI (described below). Selection of a stop-by place and the like is received from the user through a screen of GUI. Moreover, changes of a moving route or subsequent stop-by places displayed by GUI may be sequentially screened in consideration of an estimated required time which is a time estimated to be required for a stop-by place selected by the user.

Furthermore, in presenting information, stop-by place candidates to be presented to the user may be appropriately screened. For example, in a case where a large number of stop-by place candidates are present in the moving route, it may be difficult to present all the candidates on a GUI screen, or browse the candidates for the user. In this case, execution of screening is considered to be more preferable.

Next, examples of selection method of stop-by place candidates are hereinafter listed.

(ex.3) A stop-by place to be presented is selected on the basis of a moving purpose of the user and user attribute information. For example, selected as a candidate is a stop-by place of a type related to a moving purpose (e.g., sightseeing, date, eating around, and banquet) input through a GUI screen (described below) presented at the time when the user boards the vehicle. Furthermore, information regarding preference of the user (e.g., music, food, and sports) is acquired, and a stop-by place of a type agreeing with this information is selected as a candidate. For example, selected as a stop-by place candidate is a restaurant in a favorite category of the user, a stadium of a favorite sport event of the user, a special agent of a favorite team of the user, or the like. Examples of a method for acquiring attribute information regarding the user include a method of inputting information by the user via the input unit 21, a method of estimating information on the basis of a behavior history of the user accumulated in the vehicle, and a method of acquiring information from an information terminal device possessed by the user.

(ex.4) A stop-by place candidate is selected on the basis of a destination arrival time. When a moving route allowing arrival at a destination before a destination arrival time even with use of a stop-by place can be searched on the basis of an estimated required time for using a stop-by place (e.g., time from entrance into store to finishing food, and observation time of facility), this stop-by place is selected as a candidate.

(ex.5) A stop-by place candidate is selected on the basis of an in-vehicle state. For example, in a case where a situation of drinking wine is detected from an image captured inside the vehicle, places or facilities providing a fantastic night view are included in stop-by place candidates. Moreover, in a case where a state that the user is wearing formal clothes is detected from an image captured inside the vehicle, art museums, museums or the like are included in stop-by place candidates. Furthermore, in a case where a state that the user is an aged person is detected from an image captured inside the vehicle, temples and shrines are included in stop-by place candidates. In addition, in a case where a plurality of users are present, stop-by place candidates may be selected according to relationships between the users. Moreover, in a case where it is determined that the same food or drink is repeatedly ordered from an image captured inside the vehicle, a store similarly providing the same food or drink to the user next time is presented as a stop-by place candidate, for example. Furthermore, in a case where some food or drink is left unfinished, whether to present a store providing the same dish or drink as a stop-by place candidate may be determined in accordance with an unfinished amount. In addition, selected may be such a stop-by place candidate which provides an appropriate and constant quantity of food or drink in the interior of the vehicle in accordance with a frequency of order of food or drink, an unfinished amount, and a number of using persons on board. Moreover, in a case where similar food or drink is providable from a plurality of stores in a moving route, stores other than the stores providing the same food or drink may be selected as stop-by place candidates by determining food not finished yet or food left unfinished on the basis of an image captured inside the vehicle.

(ex.6) A physical condition or a degree of satiety or hunger of the user is estimated on the basis of a recognition result of the user's face from an image captured by the in-vehicle camera or a detection result obtained by the biometric sensor to determine whether or not a residual amount of meal inside the vehicle is appropriate. If the residual amount of meal is equal to or larger than an appropriate amount, a store providing the same food or drink is excluded. If the residual amount is smaller than the appropriate amount, a store providing the same food or drink is selected as a candidate to be presented.

(ex.7) A stop-by place candidate is selected in accordance with a stop-by place already used by another user. For example, a place stopped by already by many other users whose destinations are the same is included in stop-by place candidates. Moreover, a place stopped by subsequently by many other users whose stop-by place is the same may be included in stop-by place candidates. Furthermore, stop-by place candidates may be selected by utilizing a search result obtained by a related person, for example, who is a person related to the user and using the search result, on the basis of related person information acquired as information indicating the related person. In this case, stores, facilities or the like recommended by the related person may be set as stop-by place candidates.

(ex.8) Stop-by place candidates are updated in accordance with a previous moving route, stop-by place, and use history. For example, information regarding a moving route of previous traveling, and a stop-by place actually stopped by (e.g., sightseeing spot) is obtained. A recommended souvenir to purchase is estimated on the basis of the acquired information. A store where the recommended souvenir can be purchased is included in stop-by place candidates if the souvenir is not purchased yet with reference to a previous purchase history of the user. Moreover, places, facilities or the like in the same category as the category of a used stop-by place (e.g., art museum exhibiting similar art works, or store selling similar clothes and the like) may be selected as stop-by place candidates. Furthermore, places and facilities in the same category as the category of a used stop-by place (e.g., restaurant serving similar food) may be excluded from stop-by place candidates. In addition, a stop-by place selected once by the user, and a stop-by place included in the same category as the category of the stop-by place selected once or a similar category are excluded from next and later proposals for a certain period. For example, in a case where a stop-by place selected by the user is a Chinese restaurant, not only this Chinese restaurant but also other Chinese restaurants are excluded from next and later proposals. In addition, on the basis of selection of the Chinese restaurant, candidates are narrowed down by setting a next proposal to a store related to desserts or sweets, for example. In this manner, stop-by place candidates to be visited next and later may be narrowed down on the basis of a selected stop-by place.

(ex.10) The number of stop-by place candidates is narrowed down in accordance with a time remaining till a destination arrival time. For example, the number of stores to be presented is narrowed down as a time remaining till a destination arrival time becomes shorter.

(ex.11) A stop-by place is selected in accordance with a destination arrival time. Even in case of a facility or the like allowed to be stopped by, such a stop-by place difficult to reach by a destination arrival time after use of the place is not presented. For example, whether or not arrival at a destination by a destination arrival time is possible may be determined by estimating a cooking time at a store allowed to be stopped by and considering the estimated cooking time and the like. Note that information regarding the cooking time and the like may be acquired from a store allowed to be stopped by.

(ex.12) A stop-by place is selected in accordance with a budget of the user. For example, stop-by places requiring a cost higher than a budget set by the user by addition of a viewing fee, and stop-by places requiring a cost higher than the budget by high prices of commodities and foods are excluded from stop-by places.

(ex.13) A stop-by place is selected in accordance with available service information possessed by the user. For example, in a case where the user possesses a service point, it is also preferable to use the service point during moving to a destination. Therefore, a store where the service point possessed by the user is usable is included in stop-by place candidates.

(ex.14) It is also preferable to change an estimated required time for a stop-by place in accordance with the user. For example, in a case where an exhibition or the like suitable for preference of the user is held, the user may desire to observe the exhibition or the like for a sufficient time. In this case, it is preferable to increase an estimated required time used for search for a moving route. Accordingly, a stop-by place may be selected by using an estimated required time for a stop-by place adjusted in accordance with preference of the user or an instruction from the user.

(ex.15) When a large number of users are present, an observation time increases, for example. In this case, a stop-by place may be selected with adjustment of an estimated required time for a stop-by place in accordance with the number of users.

The mobile device 20 may present stop-by place candidates to the user together with a moving route by using GUI, or may present the candidates to the user by using GUI when the user comes close to the stop-by place candidates. For example, information regarding a stop-by place is presented a predetermined time (e.g., 15 minutes) before an estimated arrival time at the stop-by place candidate. The information is presented in this manner because the user needs to go back and use a presented stop-by place if the stop-by place is presented after the user passes the place.

Next, examples of the route search method are hereinafter listed.

(ex.16) Route search is performed in a descending order of priority of stop-by place candidates on the basis of priority set in advance for each stop-by place. In route search, the user can purchase commodities at low cost by setting high priority for a stop-by place candidate which sets a high discount rate, for example. Moreover, the number of customers of an affiliated restaurant or the like increases by setting high priority for the affiliated restaurant or the like as a stop-by place candidate.

(ex.17) Route search is performed within an area designated under the search conditions described above. In route search, a moving route agreeing with an intention of the user can be searched without search of a moving route which uses a stop-by place located in a region not desired by the user by restricting a search range to a designated area.

(ex.18) Route search is performed in such a manner as to search a moving route which includes stop-by place candidates selected on the basis of reproduced music information indicating music being reproduced within the vehicle boarded by the user. By performing route search on the basis of the reproduced music information indicating music being reproduced within the vehicle in this manner, a moving route suitable for preference of the user can be searched.

(ex.19) Route search is performed in accordance with an estimated required time set for a stop-by place candidate in a state that the estimated required time is allowed to be set for the stop-by place candidate. For example, in setting a required time for a stop-by place, it is estimated that a use time increases in a case where the stop-by place considerably matches preference of the user. In this case, a longer estimated required time is set for the stop-by place candidate so that a moving route can be searched with appropriate estimation of a situation where the user uses the stop-by place. Accordingly, in a case where the stop-by place is desired to be used for a sufficient time, for example, an estimated required time is set longer than a preset required time. In a case where the place is desired to be used in a simple manner, an estimated required time is set shorter than the preset required time.

(ex.20) Route search is performed by using use time information acquired on the basis of a stop-by place candidate and indicating use time of the stop-by place candidate. A use start time and a use end time of services are set for a stop-by place. Furthermore, a required time for a stop-by place may vary depending on a time zone. For example, the required time increases at a congestion time. Accordingly, in route search, a moving route such as a route reaching a stop-by place within a period from a use start time to a use end time, and a route reaching a stop-by place while avoiding a crowded time zone, is searched in consideration of use time information regarding stop-by place candidates, such as a use start time, use end time, and time zone of congestion, for example.

(ex.21) Route search is performed in accordance with a use state of a stop-by place candidate. In route search, search is performed while adjusting a stop-by order in accordance with an activity use state, such as a waiting time and a congestion state in a stop-by place, for example. For example, reduction of a waste of time and efficient use of a stop-by place are achievable by searching a moving route with high priority set to stop-by place candidates producing less waiting time or congestion.

(ex.22) A moving route is changed on the basis of in-vehicle information indicating a situation inside the vehicle. A facial expression of the user or biological information (perspiration and heartbeat) of the user are acquired as in-vehicle information. An emotion (enjoyment and discomfort), hunger, drowsiness and the like of the user are recognized from the in-vehicle information to urge a change of a moving route in accordance with a recognition result.

(ex.23) A moving route is searched such that a stop-by place candidate allowing use of service information possessed by the user is included. This manner of route search achieves effective use of service information possessed by the user.

(ex.24) The user is allowed to use a stored search result. The user is allowed to select a search result stored in the information database unit 53, and use the search result. For example, a moving route can be easily set with reference to information regarding a stop-by place without a necessity of selecting a stop-by place or the like by using a search result obtained by another user who sets the same destination and a similar destination arrival time.

(ex.25) It is necessary to assume use of a bathroom or the like in a case where a moving time increases. In this case, a route which passes through the vicinity of a predetermined facility (facility equipped with bathroom) for each predetermined moving distance is searched.

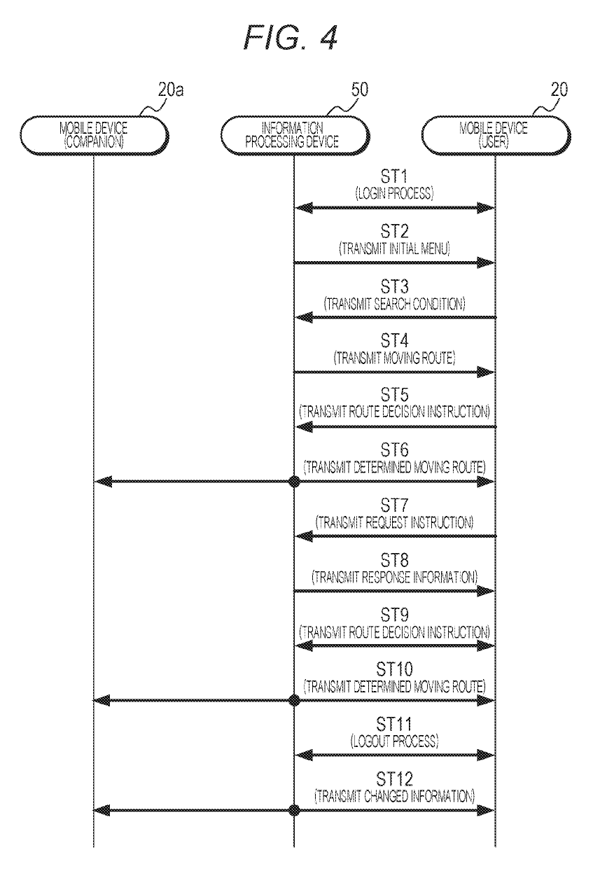

FIG. 4 is a sequence diagram illustrating an example of an operation of the information providing system. In FIG. 4, the mobile device 20 is a device used by a user who uses a search result of a moving route, while a mobile device 20a is a device used by a companion who moves with the user, for example. The information processing device 50 is a device which searches for a moving route to a destination corresponding to a destination arrival time, together with stop-by place candidates corresponding to a moving purpose, on the basis of a route search request from the user or the like, and transmits a search result to the mobile device 20 and the mobile device 20a.

In step ST1, the mobile device 20 and the information processing device 50 perform login processing. The mobile device 20 transmits information indicating identification information, a password or the like of the user to the information processing device 50. The information processing device 50 determines whether a connection request is a request from an authorized user on the basis of the received identification information, password or the like. In a case where the information processing device 50 determines that the connection request is a request from the authorized user, the information processing device 50 performs processing in step ST2. Note that connection is rejected in a case where the connection request is a request from an unauthorized user.

In step ST2, the information processing device 50 transmits an initial menu. The information processing device 50 generates display information indicating the initial menu, and transmits the display information to the mobile device 20. The initial menu includes an input screen through which the user inputs search conditions. The input screen is configured to receive input of a destination, destination arrival time, and moving purpose. Furthermore, the input screen may be configured to receive input of user attribute information, such as preference (e.g., music, food, and sports), age, and gender of the user, and number of using persons (number of persons including companion), for example.

In step ST3, the mobile device 20 transmits search conditions. The mobile device 20 transmits, to the information processing device 50, search conditions input by the user on the basis of the initial menu.

In step ST4, the information processing device 50 transmits a moving route. The information processing device 50 performs route search on the basis of the search conditions transmitted from the mobile device 20. In route search, a moving route to a destination in accordance with a destination arrival time indicated in the search conditions is searched together with stop-by place candidates corresponding to a moving purpose. The information processing device 50 transmits a search result to the mobile device 20.

In step ST5, the mobile device 20 transmits a route decision instruction. The mobile device 20 presents the search result received from the information processing device 50 to the user. Furthermore, the mobile device 20 transmits the route decision instruction to the information processing device 50 in response to selection of the presented moving route by the user on the basis of an operation input to the input unit 21 by the user.

In step ST6, the information processing device 50 transmits the determined moving route. The information processing device 50 transmits route guidance of the moving route selected by the user to the mobile devices 20 and 20a. Note that a current location, stop-by information, in-vehicle information and the like are transmitted from the mobile device 20 to the information processing device 50 in the route guidance. Furthermore, the information processing device 50 sequentially provides route guidance reflecting the current location of the mobile device 20, stop-by information, in-vehicle information and the like.

In step ST7, the mobile device 20 transmits a request instruction. In a case where it is determined that the user has issued a request instruction to change a moving route, a request instruction to add or change a stop-by place, a request instruction to request information regarding a stop-by value or the like, the mobile device 20 transmits the request instruction of the user to the information processing device 50.

In step ST8, the information processing device 50 transmits response information. On the basis of the request instruction from the mobile device 20, the information processing device 50 generates response information indicating information regarding a new moving route or stop-by place, and transmits the response information to the mobile device 20.

In step ST9, the mobile device 20 transmits a route decision instruction. The mobile device 20 presents the response information received from the information processing device 50 to the user. Furthermore, the mobile device 20 transmits a route decision instruction to the information processing device 50 in response to selection by the user for selecting the moving route or the like indicated in the response information on the basis of an operation by the user through the input unit 21.

In step ST10, the information processing device 50 transmits the determined moving route. The information processing device 50 transmits route guidance or the like of the moving route selected by the user and subjected to change to the mobile devices 20 and 20a. Note that a current location, stop-by information, in-vehicle information and the like are transmitted from the mobile device 20 to the information processing device 50 in the route guidance. Furthermore, the information processing device 50 sequentially provides route guidance reflecting the current location of the mobile device 20, stop-by information, in-vehicle information and the like.

In step ST11, the mobile device 20 and the information processing device 50 perform logout processing. In a case where the mobile device 20 arrives at the destination or where a connection end operation is performed by the user, the mobile device 20 and the information processing device 50 perform a logout process to end connection between the mobile device 20 and the information processing device 50.

In step ST12, the information processing device 50 transmits changed information. In a case where the moving route changes, such as a case where it is assumed that an estimated arrival time will be delayed from the destination arrival time in the presented moving route due to traffic jam, for example, the information processing device transmits a new moving route to the mobile devices 20 and 20a.

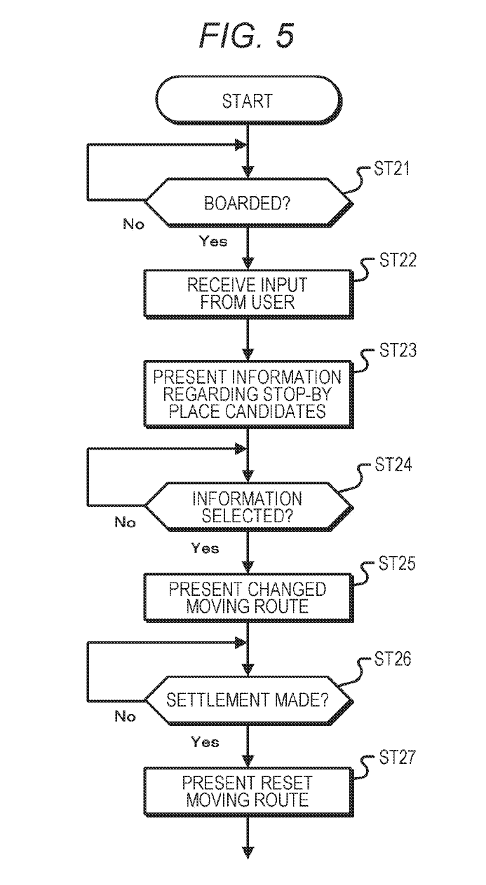

Described next by way of example of an operation of the information providing system is a case where the moving purpose is eating around. FIG. 5 is a flowchart showing a basic processing procedure for presenting information to the user. In step ST21, the mobile device 20 determines whether the vehicle has been boarded. The mobile device 20 checks the presence or absence of boarding by the user on the basis of an image captured by the in-vehicle camera, or a detection result obtained by the in-vehicle state detection unit 27 such as a load sensor, for example. In a case where the vehicle is determined to have been boarded, the process by the mobile device 20 proceeds to step ST22. In a case where the vehicle is not determined to have been boarded, the process returns to the step ST21.

In step ST22, the mobile device 20 receives input from the user. The mobile device 20 presents a GUI screen of an initial menu on the display unit 22, and receives input of search conditions and the like from the user. Thereafter, the process proceeds to step ST23.

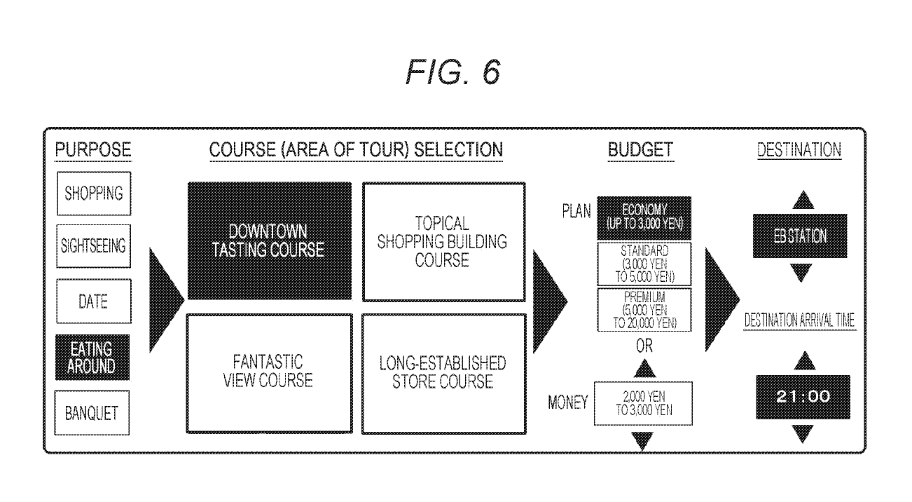

FIG. 6 illustrates a configuration example of a GUI screen of an initial menu. The user can designate a moving purpose, a geographical area through which the user desires to pass during moving, a budget (plan or price range) allowed to be paid at a stop-by place until arrival at a destination, a destination, a destination arrival time and others by menu selection operation or the like on the GUI screen shown in the figure. According to the example illustrated in the figure, selected are “eating around” for a moving purpose, “downtown tasting course” for a course, and an “economy plan” assuming a budget equal to or lower than 3,000 yen, and set are an “EB station” for a destination, and “21: 00” for destination arrival time.

Note that the user may input information stored beforehand in an information terminal device possessed by the user and read as information similar to information input through the GUI screen to provide search conditions, rather than input by the user through the GUI screen illustrated in FIG. 6.

In step ST23, the mobile device 20 presents information regarding stop-by place candidates on the basis of the input information. The mobile device 20 displays, on the display unit, guidance of a moving route selected by the user from moving route candidates searched in response to input of the search conditions. Furthermore, in the guidance of the moving route, information regarding available stop-by place candidates corresponding to a moving purpose is converted into a GUI screen, and displayed on the display unit. Thereafter, the process proceeds to step ST24.

The information processing device 50 searches for such a moving route matching a purpose designated by the user or a selected course, and expected to achieve arrival at the destination by a destination arrival time, for example. Moreover, available stop-by place candidates are extracted in accordance with the moving route. Furthermore, the information processing device 50 may select stop-by place candidates on the basis of attribute information such as a moving purpose, boarding course, budget, and preference of the user designated on the GUI screen illustrated in FIG. 6.

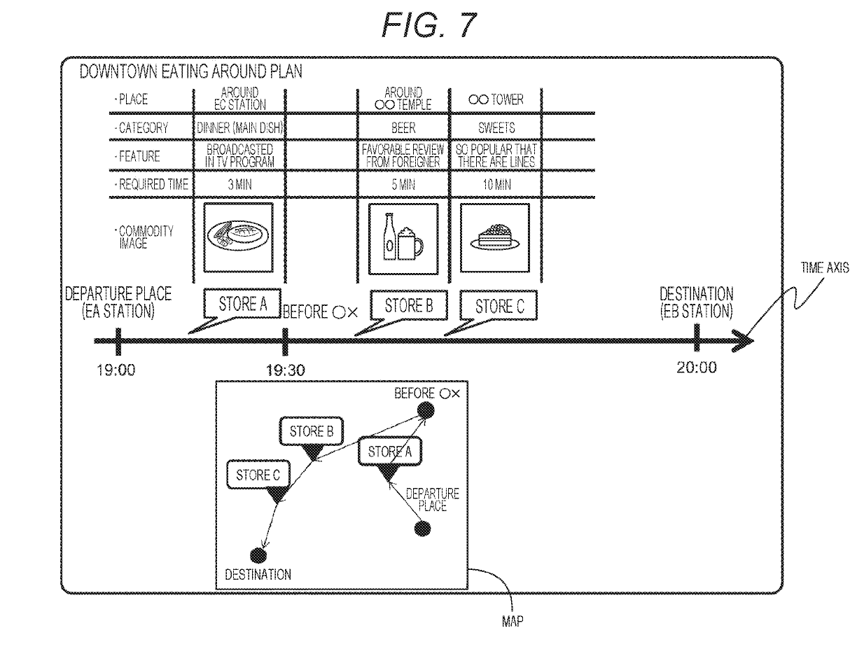

FIG. 7 illustrates a configuration example of a GUI screen for presenting, on the mobile device, a moving route and stop-by place candidates available in the moving route. In the GUI screen illustrated in the figure, a moving route and stop-by places (e.g., store A, store B, store C, before ∘x) are displayed on a map. Furthermore, a time axis indicating a path plan is displayed on the same GUI screen. This time axis is a horizontal line which has a left end indicating a departure place (“EA station” in illustrated example, or departure place may be current location of user rather than departure place), and a right end indicating a destination (“EB station” in illustrated example). The icons of the stop-by places described above are displayed on the time axis in time series in accordance with an estimated arrival time to each of the stop-by places.

Furthermore, the stop-by place candidates are displayed on the same GUI screen at positions on the time axis showing the path plan in a stop-by order of the via-points and destination. For example, information regarding a commercial facility as a stop-by place candidate and shown in matrix is displayed at a position in a stop-by order, more specifically, information regarding the store A is displayed between the departure place “EA station” and the via-point (stop-by place) “before ◯x”. While FIG. 7 is a simplified illustration for convenience, it is preferable that the information regarding the commercial facility includes (1) name and location of the commercial facility, (2) commodities and services provided by the commercial facility, and estimated required time, and (3) reason for recommending the stop-by place candidate, for example. Commercial facilities assumed herein include any types of commercial facilities, such as leisure facilities, various stores, shopping malls, restaurants, and convenience stores.

Each cell (place, category, feature, commodity image) of the matrix displaying information regarding each commercial facility is a selectable menu button. In response to selection of a cell by the user, another data candidate group having the same attributes is displayed on a pull-down menu (not shown). In response to designation of another data candidate by the user, the screen is updated to a screen displaying similar information regarding the designated data candidate. Furthermore, in response to swiping operation (swiping with touch by fingertip) for one of icons of respective commercial facilities (store A to store C), display switches to another store candidate having similar conditions (place, category, and feature).

For example, the user can select a stop-by place by issuing an instruction using an icon on the map or in time series showing the moving route on the GUI screen illustrated in FIG. 7. Furthermore, the user can select commodities and services the user desires to use at the stop-by place (e.g., commercial facility) by issuing an instruction using the corresponding cell in the matrix.

In step ST24, the mobile device determines whether information has been selected. In a case where the user does not select an icon of a stop-by place candidate on the GUI screen illustrated in FIG. 7, the process of the mobile device 20 returns to step ST24. In a case where selection has been made, the process of the mobile device 20 proceeds to step ST25.

In step ST25, the mobile device presents a changed moving route. The mobile device 20 notifies the information processing device 50 that the stop-by place has been selected, and displays route information regarding the changed moving route transmitted from the information processing device 50 to the mobile device in response to this notification. The information processing device 50 searches for a new moving route which uses the stop-by place in consideration of information regarding the selected stop-by place, current location of the user, destination, current time, and destination arrival time. Furthermore, each estimated arrival time of stop-by place candidates in the new moving route is recalculated. Display of each estimated arrival time on the time axis of the GUI screen is updated.

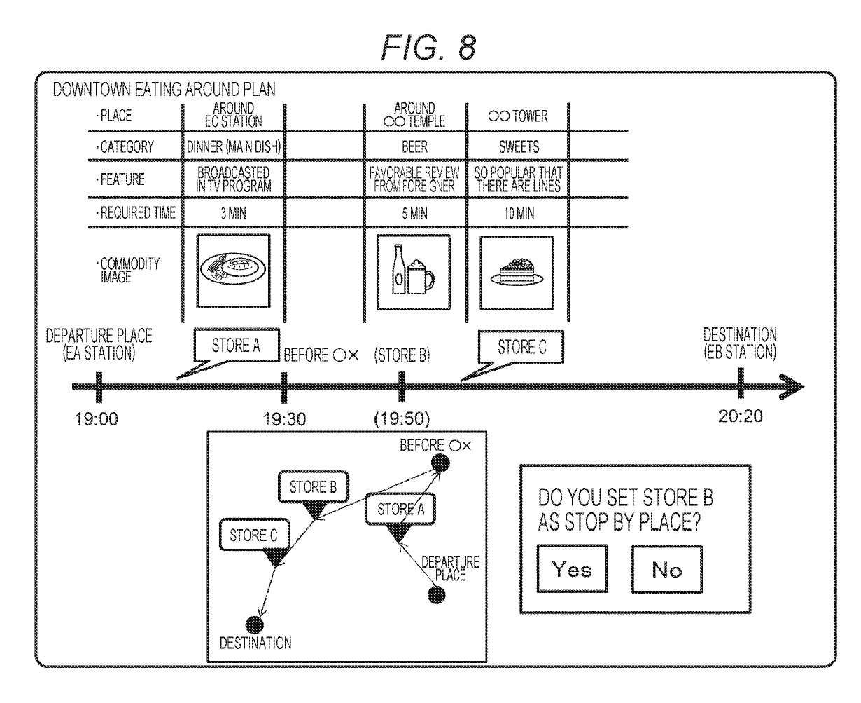

FIG. 8 illustrates an example of a GUI screen whose display has been updated in response to selection (temporary setting) of a stop-by place from stop-by place candidates. For example, it is assumed that an icon of the “store B” on the moving route, or an icon of the “store B” on the time axis display is selected as the stop-by place. However, an operation of selecting an icon of a commercial facility alone achieves only a temporary setting state. In this case, decision has not been made yet. According to the example illustrated in the figure, temporary setting is indicated by a change of icon display of the store B to display with parentheses on the time axis display. Furthermore, the information processing device 50 recalculates an estimated arrival time of each point in a case where the moving route passes through the current location of the vehicle, the stop-by place, the store B, and the destination, and updates display of each estimated arrival time on the time axis of the GUI screen. The estimated arrival time at the store B in the temporary setting state is displayed with parentheses.

Furthermore, a dialog box appears on the GUI screen in the state that the commercial facility “store B” is temporarily set as illustrated in FIG. 8 to provide confirmation for the user that the store B is to be set as a stop-by place. According to the example illustrated in the figure, the dialog box displays a message “Do you set store B as stop-by place?”, while presenting a “Yes” button for affirming the setting and a “No” button for negating the setting.

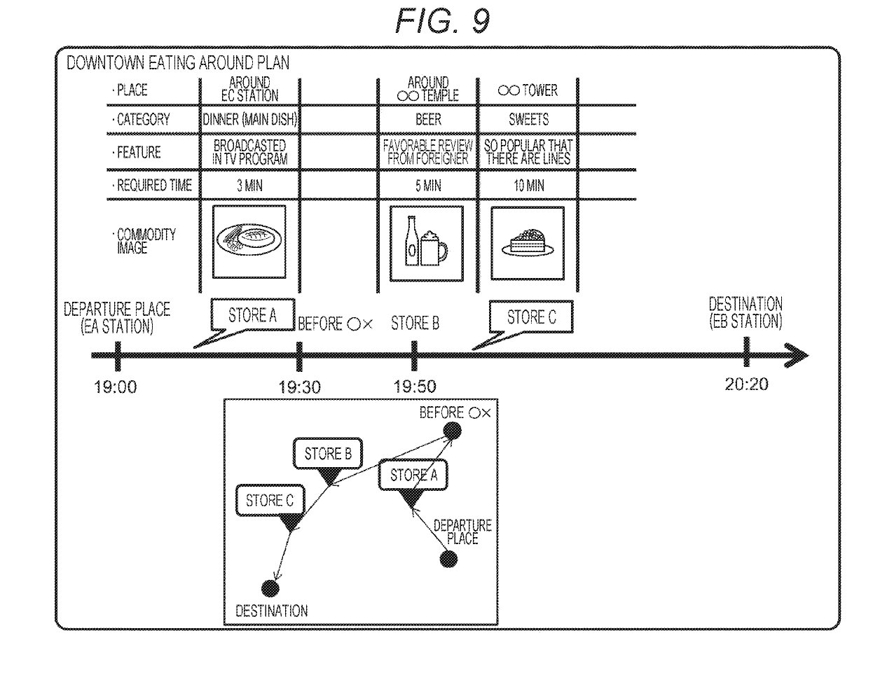

In response to selection of the “Yes” button by the user in this dialog box, setting the store B as a stop-by place is decided. Then, the parentheses disappear from the display of the store B and the estimated arrival time of the store B on the GUI screen as illustrated in FIG. 9 to indicate that the commercial facility “store B” has been decided as a stop-by place.

Steps ST24 and ST25 described above are processing performed in a case where the user sets a stop-by place by operating an icon of a commercial facility on the GUI screen illustrated in FIG. 7. On the other hand, the user may select a cell of a commodity image on the matrix displayed on the GUI screen to simultaneously select a place corresponding to the cell (commercial facility) and a commodity to be used at the commercial facility. However, selection of a cell on the matrix is only temporary setting. Decision of the selection has not been made yet. In response to notification that a cell of a commodity has been selected, the information processing device 50 recalculates each estimated arrival time of the stop-by place and the respective commercial facilities, and updates display of each estimated arrival time on the time axis of the GUI screen in a case where the moving route further includes the corresponding commercial facility as a stop-by place, in consideration of the current location of the user, destination, and use of the selected commodity at the corresponding commercial facility (e.g., time required for eating selected food at store).

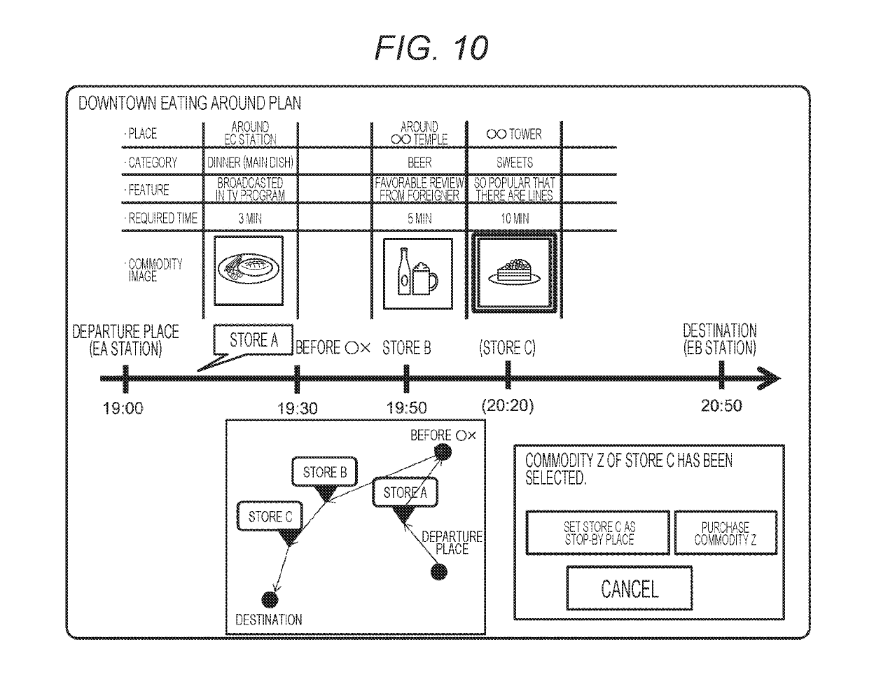

FIG. 10 illustrates an example of a GUI screen updated in response to selection by the user for selecting a cell of a “commodity Z” of a stop-by place, such as the commercial facility “store C”, on the matrix of the GUI screen illustrated in FIG. 9. On the time axis showing the route plan, the commercial facility “store C” is newly and temporarily set as a new stop-by place. The icon display changes to display with parentheses. Furthermore, each estimated arrival time of the points, given in a case where the moving route passes through the current location, stop-by place, already decided store B and store C, and destination, is updated. The estimated arrival time at the temporarily set store C is displayed with parentheses.

Furthermore, the GUI screen in a state that the “commodity Z” providable at the commercial facility “store C” illustrated in FIG. 10 is temporarily set shows a dialog box to provide confirmation for the user about whether the store C is set as a stop-by place, or whether or not the screen is shifted to a purchase screen of the commodity Z. According to the example illustrated in the figure, the dialog box displays a message “commodity Z of store C has been selected”, while presenting a “set store C as stop-by place” button for determining setting of a stop-by place, and a “purchase commodity Z” button for proceeding to a purchase procedure of the commodity Z.

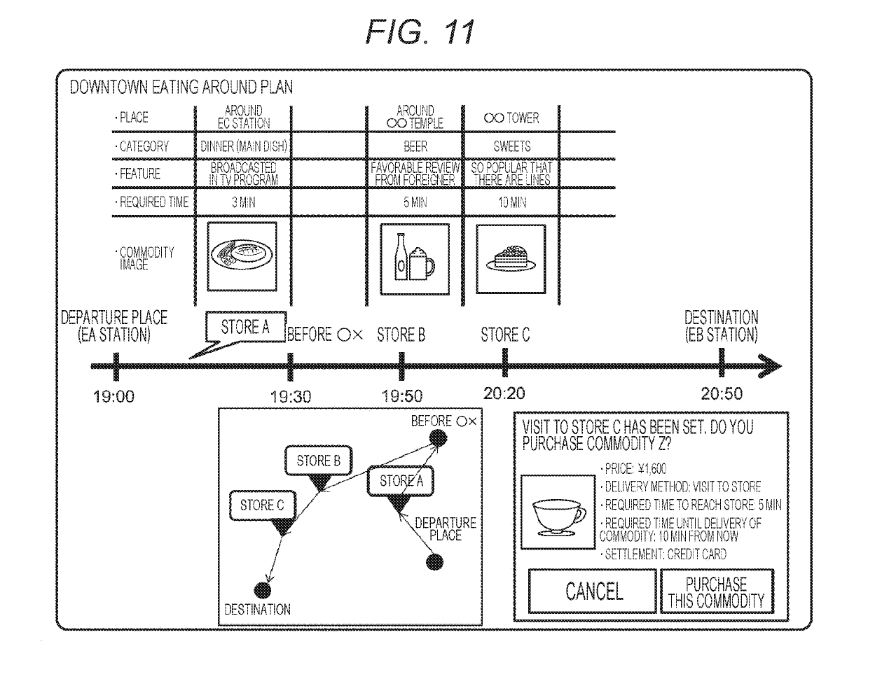

The user selects the “set store C as stop-by place” button on the GUI screen in FIG. 10 to decide the commercial facility “store C” as a stop-by place. FIG. 11 illustrates an example of an updated GUI screen after decision of a new stop-by place. The figure shows disappearance of parentheses from the display of the store C and the estimated arrival time of the store C, indicating that the commercial facility “store C” has been decided as a stop-by place.

In addition, in this case, stopping by at the commercial facility “store C” has been decided, but commodities and services used in the commercial facility have not been decided yet. According to this example, purchase of the cell “commodity Z” selected by the user on the GUI screen in FIG. 11 has not been decided yet. Therefore, a dialog box appears to provide confirmation for the user about whether or not to purchase the commodity Z. According to the example illustrated in the figure, a dialog box to be displayed includes “Visit to store C has been set. Do you purchase commodity Z?”, as well as detailed information regarding a price, delivery method, required time to reach the store, required time until delivery of the commodity, settlement method, and other conditions and the like for purchasing commodity Z, and also presents a “cancel” button for instructing cancellation of purchase of the commodity Z, and a “purchase this commodity” button for deciding purchase of the commodity Z. Selection of the “cancel” button may achieve not only cancellation of purchase of the commodity Z, but also cancellation of the “store C” as a stop-by place.

Selection of the “purchase this commodity” button in this dialog box by the user completes a purchase process at a price and a settlement method (e.g., credit card payment) described in the dialog box. Thereafter, the commodity Z is allowed to be received by the delivery method described in this dialog box. Note that, in a modified example, the store C may be decided as a stop-by place simultaneously with decision of purchase of the commodity Z after selection of the “purchase this commodity” button in the dialog box illustrated in FIG. 11, rather than at the time of selection of the “set store C as stop-by place” button in the dialog box illustrated in FIG. 10. In this modified example, the necessity of presenting the “set store C as stop-by place” button in the dialog box is eliminated. Note that a settlement process is performed by decision of purchase of the commodity Z in response to selection of the “purchase this commodity” button by the user on the GUI screen of FIG. 11.

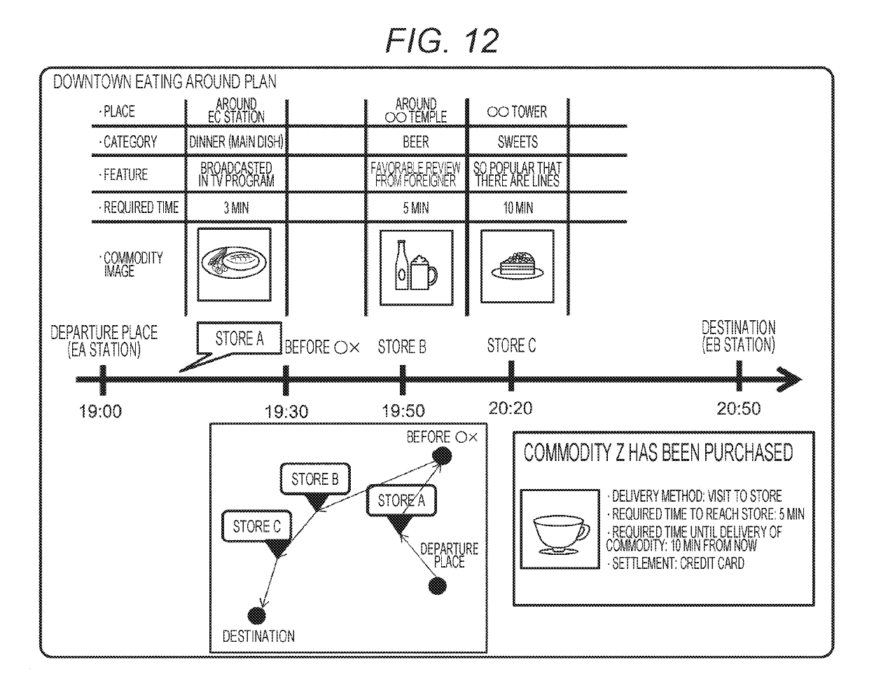

With decision of purchase of the commodity Z at the store C, the GUI screen shows a pop-up window describing information regarding completion of purchase of the commodity Z and the delivery method as illustrated in FIG. 12. According to the example illustrated in FIG. 12, the pop-up window displays a message “commodity Z has been purchased”, as well as detailed information regarding delivery of the commodity Z and the like, such as delivery method, time required to reach the store, time required until delivery of the commodity, and settlement method. Furthermore, on the time axis indicating the route plan, a balloon that describes completion of purchase of the commodity Z, a delivery time and the like is added to the “store C”. Note that a similar screen transition may be achieved in a case where the user selects the “purchase commodity Z” button on the GUI screen shown in FIG. 10.

The process procedure performed by the mobile device 20 to present information inside the vehicle continues with reference to FIG. 5 again.

After the process proceeds from step ST25 to step ST26, the mobile device determines whether settlement has been made. The process performed by the mobile device 20 proceeds to step ST27 in a case where it is determined that selection of a certain commodity or service has been made, or settlement of the selected commodity or service has been completed by an operation such as selection of a cell on the matrix on the GUI screen illustrated in FIG. 7, rather than selection of an icon of a commercial facility such as a store. In a case where the settlement has not been completed, the process returns to step ST26.

In step ST27, the mobile device 20 presents a reset moving route. On the basis of use of the stop-by place, the information processing device 50 re-searches a moving route, sets a new moving route, and transmits the new moving route to the mobile device 20. The mobile device 20 presents the moving route reset by the information processing device to the user. Note that resetting of a moving route includes resetting of a moving route containing appropriate commercial facilities as stop-by places in consideration of the current location of the user, destination, and use of a selected commodity at the corresponding commercial facility (e.g., time required to eat selected meal at store), and recalculates each estimated arrival time of the stop-by places to update display of each estimated arrival time on the time axis of the GUI screen.

Furthermore, in step ST27, the commercial facility selected in step ST26 is decided as a place to visit (stop-by place) to reset the moving route of the user. In a case where the user boards the vehicle, for example, it is assumed that setting of the moving route includes both setting of a via-point, destination, and traveling route of the vehicle in an automatic driving mode, and setting of a via-point, destination, and traveling route on an application for navigation of the vehicle in a manual driving mode.

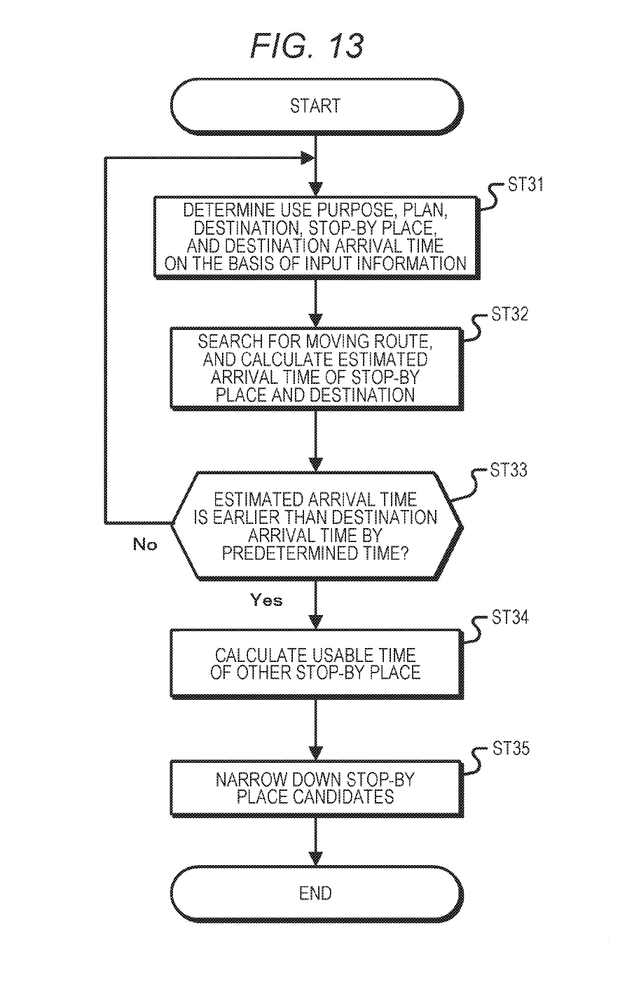

A flowchart in FIG. 13 shows a process procedure for displaying, on a GUI screen, commodities and services providable at a stop-by place in a moving route, for example. This procedure is executed in step ST23 of the flowchart shown in FIG. 5.

In step ST31, the information processing device 50 determines a purpose of use, plan, destination, stop-by place, and destination arrival time on the basis of information input from the user through the GUI screen displayed in step STT22. According to the example illustrated in FIG. 6, “eating around” as a purpose of use, “downtown tasting course” as a boarding course (plan), and the “EB station” as a destination are input to the GUI screen. In accordance with these items of information, “before ox” as a stop-by place, and “21:00” as a destination arrival time are set.

In step ST32, the information processing device 50 searches for a moving route on the basis of the current location of the user, and the destination and stop-by place set in step ST31, and calculates each estimated arrival time of the stop-by place and the destination.

In step ST33, the information processing device 50 compares the estimated arrival time of the destination with the destination arrival time input from the user in step ST21, and determines whether or not the estimated arrival time is earlier than the destination arrival time (“21: 00” in example shown in FIG. 6) by a predetermined time (e.g., 15 minutes). In a case where the estimated arrival time is later than the time before the destination arrival time by the predetermined time, the information processing device 50 returns to step ST32 to re-search for a moving route, and recalculate an estimated arrival time on the basis of the re-searched moving route. On the other hand, in a case where the estimated arrival time is earlier than the time before the destination arrival time by the predetermined time, the process performed by the information processing device 50 proceeds to step ST34.

In step ST34, the information processing device 50 calculates a consumable time for another stop-by place. The information processing device 50 calculates the consumable time by the user at another stop-by place on the basis of a difference between the estimated arrival time and the destination arrival time. Thereafter, the process proceeds to step ST35. For example, the process in step ST34 is described with reference to the example shown in FIG. 6. For example, in a case where the estimated arrival time at the EB station as the destination is “20: 00”, stopping by another stop-by place is allowed for one hour on the basis of a difference from “21: 00”.

In step ST35, the information processing device 50 narrows down stop-by place candidates. The information processing device 50 narrows down (screening) stop-by places to be presented to the user on the basis of an average time required for delivery of commodities and services associated with (providable by) the moving route and respective commercial facilities set in step ST32, and on the basis of preference of the user, and others. Then, on the basis of the narrowed down result, a GUI screen as illustrated in FIG. 7 is presented to the user by using the display unit 22 of the mobile device 20. Note that conditions for screening stop-by place candidates are the conditions described above.

For example, on the basis of a determination result that an additional time allowed to be consumed for stopping by is one hour, commercial facilities associated with “eating around” as the moving purpose and located in the vicinity of the moving route currently searched are listed up. One or a plurality of attributes (e.g., shopping, date, eating around, and banquet) corresponding to a moving purpose for each commercial facility may be managed beforehand in association with each other in the information database unit 53 so that the route search unit 52 of the information processing device 50 can refer to the information database unit 53 at the time of screening to narrow down the commercial facilities.

Moreover, the information processing device 50 narrows down stop-by places such as commercial facilities from stop-by places suitable for the purpose of use of the user by using any of following methods (1), (2), (3) and (4).

(1) The listed commercial facilities are narrowed down as candidates by selecting commercial facilities each having a shorter average requiring time set beforehand for the corresponding commercial facility for delivery of commodities and services than a time allowed to be consumed at a stop-by place.

(2) Concerning the narrowed down commercial facilities, it is determined whether or not the destination can be reached by the destination arrival time even after consumption of each required time at the commercial facilities, in consideration of an average required time set for each commercial facility for delivery of commodities and services and an estimated arrival time of the destination after stopping-by the commercial facilities. Then, the commercial facilities are narrowed down as candidates on the basis of determination that the destination is reachable by the destination arrival time after stopping by the commercial facilities.

(3) The commercial facilities are narrowed down as candidates by selecting commercial facilities associated with a moving time zone from the current location to the destination. For example, if the current time is “19: 00”, it is determined that this time zone is suitable for dinner. In this case, the commercial facilities are narrowed down as candidates by selecting commercial facilities associated with “dinner”.

(4) The commercial facilities are narrowed down as candidates by selecting commercial facilities capable of providing commodities and services associated with attributes that match preference of the user from items of commodities and services associated with the listed commercial facilities in consideration of the preference of the user. For example, in a case where alcoholic drink and suits are registered as preference of the user, commercial facilities associated with commodities and services corresponding to attributes of “beer” (belonging to subcategory of alcoholic drink) and “sweets” are selected while considering a providable time zone of the commodities and services (data acquired from stores in advance). For example, in a case where a store associated with beer but sets a beer providable time in a range out of an estimated arrival time at the store, the store is excluded from candidates.

Then, various types of information regarding each commercial facility selected as a result of further narrowing down (stores A to C in example illustrated in FIG. 6) are presented to the user through the GUI screen. The various types of information referred to herein for display include a location of a store, category of commodities and services provided by a store, estimated required time at a store, image of a typical commodity, feature of a typical commodity, and others.

Note that a commercial facility suitable for the purpose of use of “eating around” is specifically a store that can serve food and drink. For selection of a commercial facility suitable for eating around, various information items such as a place, category, feature, and commodity image are displayed in matrix to allow selection of each cell as illustrated in FIG. 7. With selection of a certain cell, not only an item corresponding to the selected cell, but also another item associated with this item are simultaneously selected. For example, selection of a cell of a commodity image is regarded as simultaneous selection of the location (store providing selected commodity), category, and feature of the corresponding commodity.

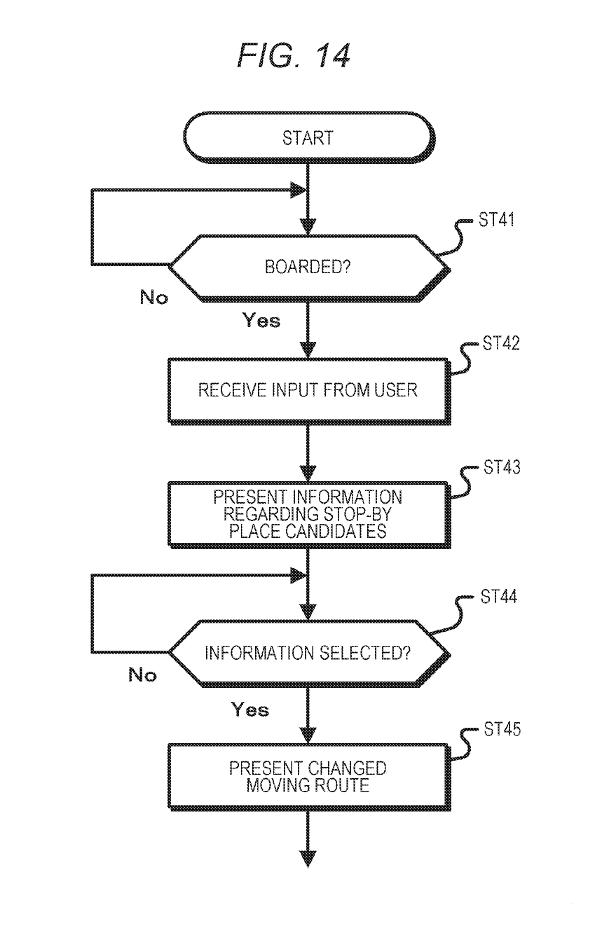

Next, a case where the moving purpose is sightseeing is described as another operation of the information providing system. FIG. 14 is a flowchart showing another basic processing procedure for presenting information to the user. In step ST41, the mobile device 20 determines whether the vehicle has been boarded. The mobile device 20 checks the presence or absence of boarding by the user on the basis of an image captured by the in-vehicle camera, or a detection result obtained by the in-vehicle state detection unit 27 such as a load sensor, for example. In a case where boarding of the vehicle is determined, the process by the mobile device 20 proceeds to step ST42. In a case where boarding of the vehicle is not determined, the process returns to the step ST41.

In step ST42, the mobile device 20 receives input from the user. The mobile device 20 presents a GUI screen of an initial menu on the display unit 22, and receives input of search conditions and the like from the user. Thereafter, the process proceeds to step ST43.

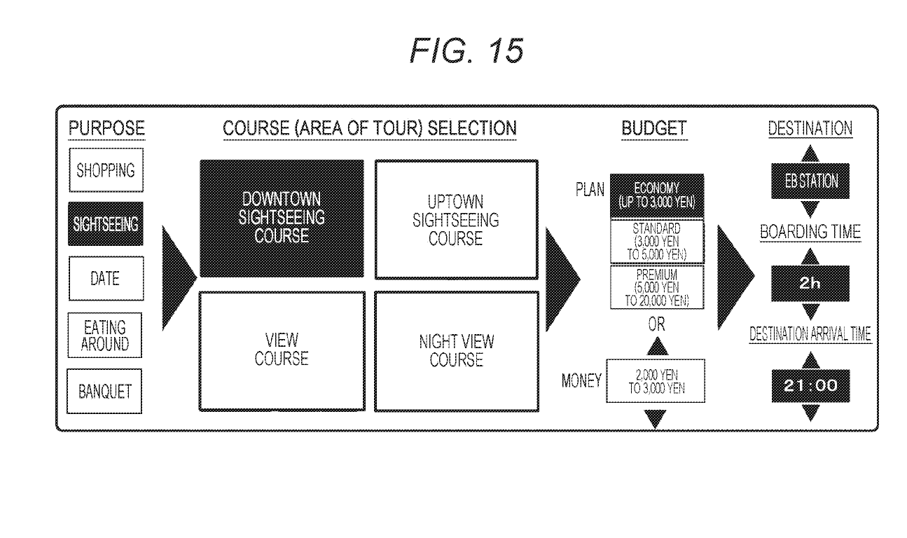

FIG. 15 illustrates a configuration example of the GUI screen of the initial menu. The user can designate a moving purpose, a geographical area through which the user desires to pass during moving, a budget (plan or price range) allowed to be paid at a stop-by place until arrival at a destination, a destination, a destination arrival time and others by menu selection operation or the like on the GUI screen shown in the figure. According to the example illustrated in the figure, selected are “sightseeing” for a moving purpose, “downtown sightseeing course” for a course, and an “economy plan” assuming a budget equal to or lower than 3,000 yen, and set are the “EB station” for a destination, “2:00” for a boarding time, and “21: 00” for a destination arrival time.

Note that the user may input information stored beforehand in an information terminal device possessed by the user and read as information similar to information input through the GUI screen to provide search conditions, rather than input by the user through the GUI screen illustrated in FIG. 15.

In step ST43, the mobile device 20 presents information regarding stop-by place candidates on the basis of the input information. The mobile device 20 displays, on the display unit, guidance of a moving route selected by the user from moving route candidates searched in response to input of the search conditions. Furthermore, in the guidance of the moving route, information regarding available stop-by place candidates corresponding to a moving purpose is converted into a GUI screen, and displayed on the display unit. Thereafter, the process proceeds to step ST44.

The information processing device 50 searches for such a moving route matching a purpose designated by the user or a selected course, and expected to achieve arrival at the destination by a destination arrival time, for example. Moreover, available stop-by place candidates are extracted in accordance with the moving route. Furthermore, the information processing device 50 may select stop-by place candidates on the basis of attribute information such as a moving purpose, boarding course, budget, and preference of the user designated on the GUI screen illustrated in FIG. 15.

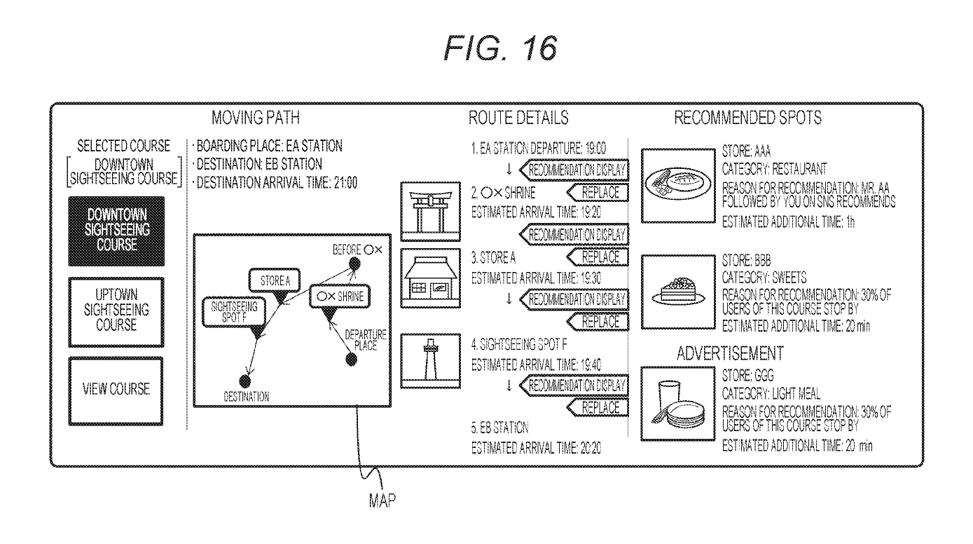

FIG. 16 illustrates another configuration example of a GUI screen for presenting, on the mobile device, a moving route and stop-by place candidates available in the moving route. The GUI screen illustrated in the figure displays information regarding selected course and moving path, route details, and recommended spots. For display of the selected course, the course selected on the GUI screen of an initial menu (e.g., “downtown sightseeing course”) is displayed in a distinguishable manner. For display of the moving path, a boarding place, destination, and destination arrival time set on the GUI screen of the initial menu are displayed. Moreover, the moving path is displayed together with a moving route and stop-by places (e.g., ox shrine, store A, and sightseeing spot F) on a map.

For display of the route details, the boarding place, stop-by places (via-points), and destination are displayed in an order of the path along with each estimated arrival time. Furthermore, icons associated with the stop-by places are displayed adjacent to the left sides of the stop-by places, for example, at information display positions of the stop-by places. The information processing device 50 also displays stop-by place candidates together with the moving route as positions in the stop-by order of the moving route via-points and the destination. An icon of “recommendation display” is displayed between respective spots of the departure place, via-points, and destination. In response to selection of the icon of “recommendation display”, information regarding the recommended stop-by place candidate is displayed in a display area of the recommended spot provided on the right side of the route display, for example. The information processing device 50 selects stop-by place candidates such as recommended commercial facilities and sightseeing spots on the basis of information input to the initial menu, preference of the user, current time, current location, number of persons on board, boarding time until now, place previously visited by the user, and the like, for example. Note that commercial facilities assumed herein include any types of facilities, such as leisure facilities, various stores, shopping malls, restaurants, and convenience stores.

FIG. 16 illustrates an example of a case where information regarding two selected stop-by place candidates is displayed on the basis of selection of “recommendation display” between the sightseeing spot F and the destination spot by the user. For the information regarding the stop-by place candidates, information such as a name, category, reason for recommendation, estimated additional time in case of use of the recommended stop-by place, and others is displayed together with an icon. Store information and the like may be displayed in the recommended spot as an advertisement.

The display of the route details may further include an icon “replace” together with “recommendation display”. The icon of “replace” is an icon for replacing the departure place, stop-by places, and destination for change. For example, in response to selection of the icon of “replace”, the information processing device 50 displays information regarding new stop-by place candidates different from the stop-by place candidates currently displayed in the display area of the recommended spot on the basis of information input to the initial menu, preference of the user, current time, current location, number of persons on board, boarding time until now, place previously visited by the user and the like.

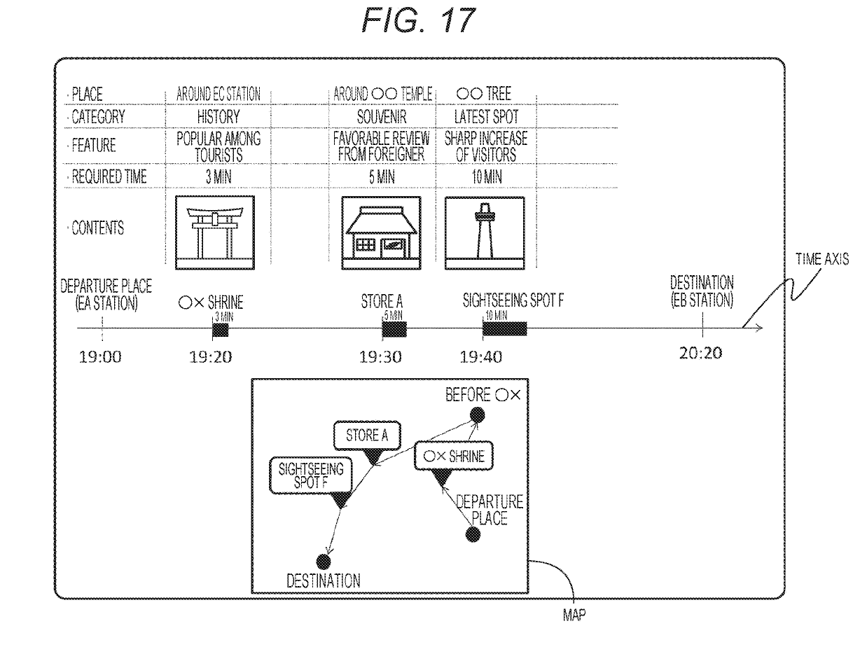

FIG. 17 illustrates a further configuration example of a GUI screen for presenting, on the mobile device, a moving route and stop-by place candidates available in the moving route. The GUI screen illustrated in the figure displays stop-by places (e.g., ox shrine, store A, and sightseeing spot F) together with a moving route on a map. Furthermore, a time axis indicating a path plan is displayed on the same GUI screen. This time axis is a horizontal line which has a left end indicating a departure place (“EA station” in illustrated example, or departure place may be current location of user rather than departure place), and a right end indicating a destination (“EB station” in illustrated example). The icons of the stop-by places described above are displayed on the time axis in time series in accordance with an estimated arrival time to each of the stop-by places. Furthermore, the GUI screen displays information regarding the via-points and destination in time series in accordance with each estimated arrival time of the via-points and destination, together with a time consumed by the user at least at each of the via-points. For example, FIG. 17 displays an estimated required time at each of the stop-by places on a bar.

Furthermore, the same GUI screen displays information regarding stop-by place candidates, such as sightseeing spots, in matrix, for example. While FIG. 17 is a simplified illustration for convenience, the information regarding the stop-by places preferably includes (1) name and place, (2) contents, estimated required time, and others.

Each cell (place, category, feature, and image) of the matrix displaying information regarding sightseeing spots and the like is a selectable menu button. In response to selection of a cell by the user, another data candidate group having the same attributes is displayed on a pull-down menu (not shown). In response to designation of another data candidate by the user, the screen is updated to a screen displaying similar information regarding the designated data candidate. Furthermore, in response to swiping operation (swiping with touch by fingertip) for the icons of the sightseeing spots and commercial facilities, display switches to another candidate of sightseeing spot or commercial facility having similar conditions (place, category, and feature).

For example, the user can select a stop-by place by issuing an instruction using an icon on the map or in time series showing the moving route on the GUI screen illustrated in FIG. 17. Furthermore, the user can select the stop-by place (e.g., sightseeing spot) by issuing an instruction using the corresponding cell in the matrix.

Returning to FIG. 14, in step ST44, the mobile device determines whether information has been selected. In a case where the user does not select a stop-by place candidate on the GUI screen illustrated in FIG. 16 or 17, the process of the mobile device 20 returns to step ST44. In a case where selection has been made, the process of the mobile device 20 proceeds to step ST45.

In step ST45, the mobile device presents a changed moving route. The mobile device 20 notifies the information processing device 50 that the stop-by place has been selected, and displays route information regarding the changed moving route transmitted from the information processing device 50 to the mobile device in response to this notification. The information processing device 50 searches for a new moving route which uses the stop-by place in consideration of information regarding the selected stop-by place, current location of the user, destination, current time, and destination arrival time. Furthermore, each estimated arrival time of stop-by place candidates in the new moving route is recalculated. Display of each estimated arrival time on the time axis of the GUI screen is updated.

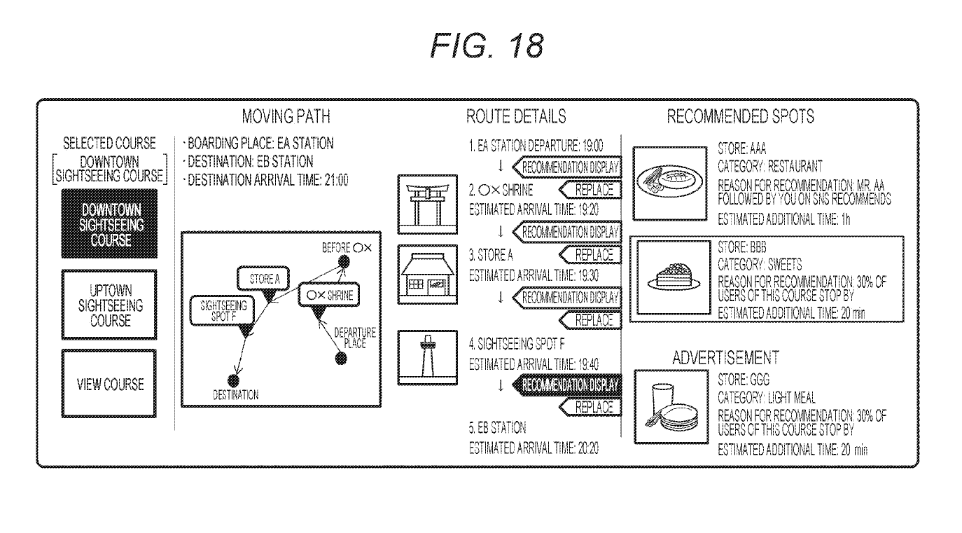

FIG. 18 illustrates an example of a GUI screen whose display has been updated in response to selection (temporary setting) of a stop-by place from stop-by place candidates. For example, it is assumed that “recommendation display” between the sightseeing spot F and the destination spot is selected by the user, and that an icon of a “store BBB” displayed at the recommended spot is selected as a stop-by place. However, an operation of selecting an icon of a stop-by place candidate alone achieves only a temporary setting state. In this case, decision has not been made yet. According to the example illustrated in the figure, temporary setting is indicated by a frame display for the information regarding the “store BBB” in the recommended spot.

The information processing device 50 further displays a dialog box, which provides confirmation for the user that “store BBB” is to be set as a stop-by place, on the GUI screen in a state that the “store BBB” has been temporarily set in a manner similar to the manner in FIG. 8. The user performs a button selection operation in the dialog box to decide the “store BBB” as a stop-by place.

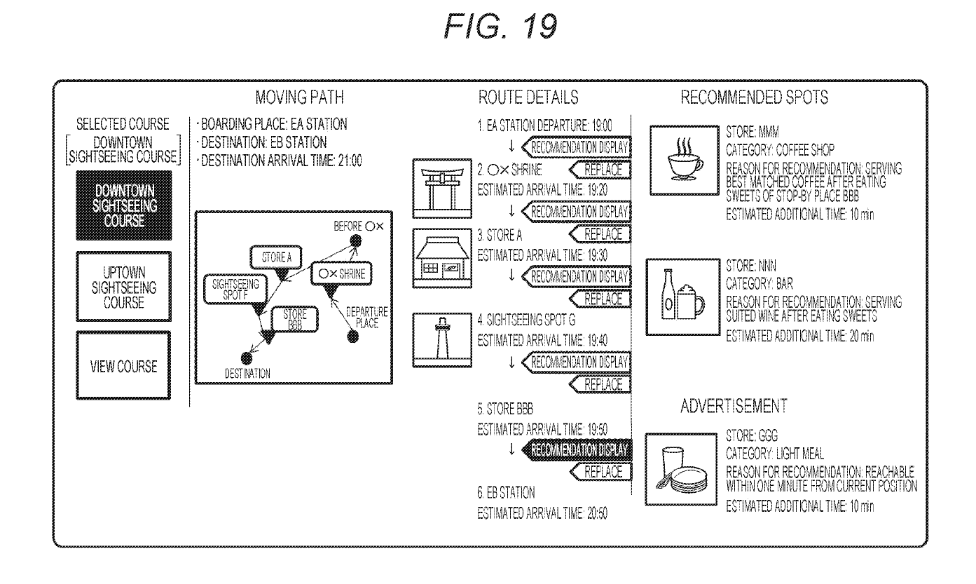

FIG. 19 illustrates an example of a GUI screen in a case where the “store BBB” has been decided as a stop-by place. The information processing device 50 adds the “store BBB” between the sightseeing spot F and the destination spot in the display of the route details. Moreover, with addition of the “store BBB”, the destination estimated arrival time in the route of the moving path and the route details is updated to a time on the assumption of stopping by the “store BBB”. Furthermore, on the basis of selection of the store BBB, displayed in the display area of the recommended spot is a spot at which stopping by is recommended after use of commodities or services provided by the store BBB (sweets are served by store BBB in this case, and recommendation of coffee is registered in advance in the information database unit 53. A “store MMM” serving this coffee as a commodity, and located near the moving route of the store BBB and the next destination (EB station) is selected and displayed as a candidate. Similarly, recommendation of wine after sweets is registered in the information database unit 53, and a “store NNN” is displayed on the basis of this registration and position information regarding the “store NNN”.

By performing this processing, stop-by place candidates between the respective spots can be presented to the user. Moreover, in response to selection of the stop-by place candidate by the user, guidance of the moving route assuming use of the selected stop-by place can be provided. For example, in a case where “sightseeing” is selected as a moving purpose, stop-by place candidates can be selected from art museums, museums, temples and shrines and the like in accordance with preference and a use history of the user or the like to dynamically update the moving route in accordance with stopping-by records of stop-by places or the like.

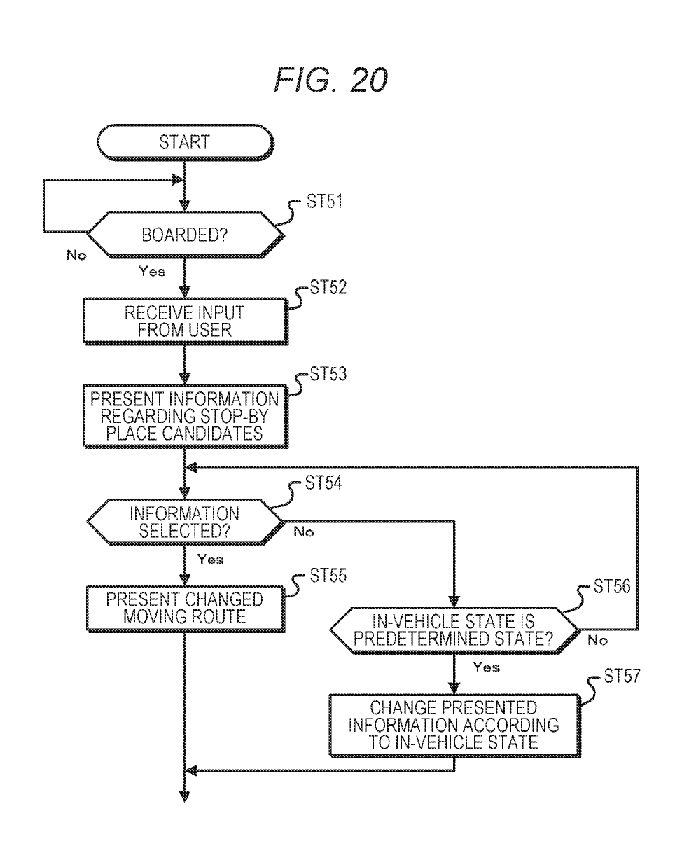

Incidentally, while the operation in FIG. 14 is the example of the case which presents stop-by place candidates or changes of routes according to an operation by the user, presentation of stop-by place candidates and change of routes may be performed on the basis of other information or the like instead of an operation by the user. Next, a processing procedure in a case where presentation of stop-by place candidates or route change is performed according to an in-vehicle state is described with reference to a flowchart shown in FIG. 20.

In step ST51, the mobile device 20 determines whether the vehicle has been boarded. The mobile device 20 checks the presence or absence of boarding by the user on the basis of an image captured by the in-vehicle camera, or a detection result obtained by the in-vehicle state detection unit 27 such as a load sensor, for example. In a case where boarding of the vehicle is determined, the process by the mobile device 20 proceeds to step ST52. In a case where boarding of the vehicle is not determined, the process returns to the step ST51.

In step ST52, the mobile device 20 receives input from the user. The mobile device 20 presents a GUI screen of an initial menu on the display unit 22, and receives input of search conditions and the like from the user. Thereafter, the process proceeds to step ST53.

In step ST53, the mobile device 20 presents information regarding stop-by place candidates on the basis of the input information. The mobile device 20 displays, on the display unit, guidance of a moving route selected by the user from moving route candidates searched in response to input of the search conditions. Furthermore, in the guidance of the moving route, information regarding available stop-by place candidates corresponding to a moving purpose is converted into a GUI screen, and displayed on the display unit. Thereafter, the process proceeds to step ST54.

In step ST54, the mobile device determines whether information has been selected. In a case where the user selects a stop-by place candidate, the process of the mobile device 20 proceeds to step ST55. In a case where no selection has been made, the process of the mobile device 20 proceeds to step ST56.

In step ST55, the mobile device presents a changed moving route. The mobile device 20 notifies the information processing device 50 that the stop-by place has been selected, and displays route information regarding the changed moving route transmitted from the information processing device 50 to the mobile device in response to this notification. The information processing device 50 searches for a new moving route which uses the stop-by place in consideration of information regarding the selected stop-by place, current location of the user, destination, current time, and destination arrival time. Furthermore, each estimated arrival time of stop-by place candidates in the new moving route is recalculated. Display of each estimated arrival time on the time axis of the GUI screen is updated.

After the process proceeds from step ST54 to step ST56, the mobile device determines whether the in-vehicle state is a predetermined state. In a case where the in-vehicle state is not a predetermined state described below, the process of the mobile device returns to step ST54. In a case where the in-vehicle state is the predetermined state, the process of the mobile device proceeds to step ST57.

In step ST57, the mobile device changes presented information in accordance with the in-vehicle state. The mobile device 20 notifies the information processing device 50 that the in-vehicle state is the predetermined state, and displays the changed moving route transmitted from the information processing device 50 to the mobile device, and information regarding the stop-by candidates in response to this notification. The information processing device 50 searches for a new moving route and selects stop-by place candidates in consideration of the in-vehicle state which is the predetermined state, the current location of the user and the destination, the current time, and the destination arrival time. Furthermore, the new moving route, each estimated arrival time of the stop-by places, and the estimated arrival time of the destination are recalculated to update display of the GUI screen of the mobile device 20.

For example, in case of detection that the user is feeling drowsy, the mobile device 20 changes the route to a quiet route, or recommends a change of stop-by places. Specifically, “Drowsiness of Mr. A has been detected. Do you change plan. change/not change” is displayed in the recommendation spot column. In a case where “change” has been selected, accommodations or resting places are searched as recommendation spots around the route between the current location and the next stop-by place or destination. The searched recommendation spots are displayed in a recommendation spot column. Moreover, in a case where a bad physical condition of the user has been detected, the stop-by places already set are deleted. A message urging a change to set the destination as the next stop-by place is displayed.

Furthermore, the mobile device may change presented information, for example, in accordance with a situation outside the vehicle as well as a situation inside the vehicle. For example, in a case where rainfall, or an outside air temperature lower than a first predetermined temperature or higher than a second predetermined temperature higher than the first predetermined temperature has been detected as a change of the weather outside the vehicle, the mobile device issues notification about recommendation of deletion of a facility requiring outdoor activities from facilities and the like set as subsequent stop-by places. Alternatively, the mobile device displays information such as information for urging a change by displaying a facility allowing indoor activities in the recommendation spot.

This processing can automatically achieve a change of a moving route or stop-by places, presentation of stop-by place candidates, and others in accordance with a state inside or outside the vehicle as well as an operation by the user.

As described above, according to the technology disclosed in the present specification, the user can sequentially check selection of stop-by places in a moving route from a departure place or a current location to a destination, and a change of schedule caused by selecting stop-by places (estimated arrival time to each stop-by place or destination) by performing a GUI operation using the mobile device 20.

The technology disclosed in the present specification can be applied to either a vehicle in an automatic operation mode or a vehicle in a manual operation mode in a case where the user uses a vehicle as a moving means. Furthermore, the user in the automatic operation mode can set via-points, destination, and moving route through a GUI screen. The user in the manual operation mode can select a via-points, destination, and moving route on an application associated with navigation.

In other words, automatic operation can be defined as a driving mode which achieves autonomous traveling to a designated destination while recognizing a surrounding environment of the vehicle by using sensing devices such as a radar, light detection and ranging (LIDAR), global positioning system (GPS), and an in-vehicle camera. It is expected in the near future that a vehicle achieving fully automatic driving appears on public roads, with further spread of advanced safe driving system (ADAS) in the future, improvement of social infrastructure such as introduction of dedicated driving lanes and lane sections, which eliminates intervention by drivers, and further easing of regulations or the like for allowing separation of drivers from vehicle control, for example.

In the fully automatic driving mode, all users are completely separated from vehicle control. Accordingly, an interior of a vehicle becomes a space for clothing, food, and housing, similar to a home living room. The user can reach a destination with substantially no consciousness of a situation inside a vehicle. The user can perform a GUI operation using the mobile device 20 to set stop-by places such as commercial facilities, and decide (perform processing such as order and settlement), inside a vehicle, commodities or services desired to be used at commercial facilities. Furthermore, sightseeing spots, commercial facilities, commodities and services and others screened according to purpose of use, course, preference of the user, budget and others are presented on a GUI screen. Accordingly, the user can enjoy selection of stop-by places, commodities, and services without feeling inconvenience, such as browsing unnecessary information.

Furthermore, a series of processes described in the specification may be executed by hardware, software, or a complex configuration of hardware and software. For executing the processes by software, programs recording process sequences are installed in a memory incorporated in dedicated hardware within a computer to be executed by the computer. Alternatively, the programs are installed in a general-purpose computer capable of executing various types of processes to be executed by the general-purpose computer.

For example, the programs may be recorded in a hard disk, a solid state drive (SSD), or a read only memory (ROM) as a recording medium beforehand. Alternatively, the programs may be temporarily or permanently stored (recorded) in a flexible disk, a compact disc read only memory (CD-ROM), magneto optical (MO) disc, a digital versatile disc (DVD), a blu-ray disc (BD) (registered trademark), a magnetic disk, a semiconductor memory card, or other removable recording media. These removable recording media may be provided as so-called package software.

Furthermore, the programs may be installed in a computer not only from a removable recording medium, but also via wireless or wired transfer to a computer through a network such as a local area network (LAN) and the Internet from a download site. A computer having received the programs transferred in this manner installs the programs in a recording medium such as a built-in hard disk.

Note that effects to be offered are not limited to the effects described in the present specification presented only by way of example, but may include additional effects not described herein. Furthermore, the present technology should not be interpreted with limitation to the embodiment of the technology described above. The embodiment of this technology discloses the present technology by way of example. It is self-evident that those skilled in the art can make modifications and substitutions of the embodiment without departing from the subject matters of the present technology. In other words, the scope of the claims should be taken into consideration to determine the subject matters of the present technology.

Furthermore, the present technology can also have following configurations.

(1) An information processing device including:

an acquisition unit that acquires a predetermined condition input by a user; and

a route search unit that acquires a moving plan including a via-point and a destination, and stop-by place candidates based on the moving plan on the basis of a moving plan search request including the predetermined condition acquired by the acquisition unit, and outputs the moving plan and the stop-by place candidates,

in which the moving plan is a plan considering a time consumed by the user at least at the via-point.

(2) The information processing device described in (1), in which the predetermined condition is any one of items concerning the user, i.e., a moving purpose, preference, gender, age, number of using persons, use time zone, destination, budget, and date and time by which arrival at the destination is necessary.

(3) The information processing device described in (1) or (2), in which the moving plan is information regarding a route along which a moving body travels, and a date and time on which the moving body travels.

(4) The information processing device described in (3), in which the route search unit acquires stop-by information regarding actual traveling of the moving body, and updates the stop-by place candidates on the basis of the acquired stop-by information.

(5) The information processing device described in (3) or (4),

in which the moving plan search request includes information indicating a situation in the moving body, and

the route search unit selects the stop-by place candidates on the basis of the acquired information indicating the situation in the moving body.

(6) The information processing device described in any one of (1) through (5), in which the route search unit acquires related person information indicating a person related to the user, and sets the stop-by place candidates on the basis of the related person information.

(7) The information processing device described in any one of (1) through (6), in which the route search unit displays, together with the moving plan, the stop-by place candidates as positions in a stop-by order of the via-point and the destination in the moving plan.

(8) The information processing device described in any one of (1) through (7), in which the route search unit acquires the moving plan that passes through the stop-by place candidates in a descending order of priority on the basis of priority set in advance for each of the stop-by place candidates.

(9) The information processing device described in any one of (1) through (8), in which the route search unit also outputs a reason for recommending each of the stop-by place candidates.

(10) The information processing device described in any one of (1) through (9),

in which the moving plan search request includes reproduced music information indicating music being reproduced in a moving body boarded by the user that uses the moving plan acquired by the route search unit, and

the route search unit selects the stop-by place candidates on the basis of the reproduced music information.

(11) The information processing device described in any one of (1) through (10),

in which the route search unit performs control to display the moving plan and the stop-by place candidates on a display unit, and

display of the moving plan is controlled such that information regarding the via-point and the destination is displayed in time series in accordance with an estimated arrival time of each of the via-point and the destination, and that a time consumed by the user at least at the via-point is also displayed.

(12) The information processing device described in any one of (1) through (11), in which the route search unit performs moving plan search using information that indicates a time consumed by the user at each of the stop-by place candidates and is acquired on the basis of the stop-by place candidates to acquire the moving plan.

(13) The information processing device described in any one of (1) through (12), in which the route search unit acquires the moving plan that passes near a predetermined facility for each predetermined moving distance.

(14) The information processing device described in any one of (1) through (13), in which the route search unit acquires the moving plan by search of the moving plan in consideration of congestion state of each of the stop-by place candidates.

(15) The information processing device described in any one of (1) through (14),

in which the moving plan search request includes information indicating a situation in a moving body boarded by the user that uses the moving plan acquired by the route search unit, and

the route search unit changes the moving plan on the basis of the acquired information indicating the situation in the moving body.

(16) The information processing device described in any one of (1) through (15),

in which the moving plan search request includes service information possessed by the user that uses the moving plan acquired by the route search unit, and

in the route search unit, a stop-by place for which the service information is available is included in the stop-by place candidate.

(17) The information processing device described in any one of (1) through (16), further including

a storage unit that stores the moving plan in a reusable manner,

in which the route search unit enables the user that uses the moving plan acquired by the route search unit to use the moving plan recorded in the storage unit.

### INDUSTRIAL APPLICABILITY

According to an information processing device, an information processing method, and a mobile device of this technology, a moving plan including a via-point and a destination, and stop-by place candidates based on the moving plan are acquired by a route search unit on the basis of a moving plan search request which includes a predetermined condition inputted by a user and acquired by an acquisition unit. Furthermore, the moving plan is a plan considering a time consumed by the user at least at the via-point. In other words, provided are an information processing device, an information processing method, and a mobile device each performing a process for providing a moving plan and stop-by place candidates from a mobile device of a vehicle or the like. Accordingly, an application range includes various types of vehicles such as automobiles (including gasoline vehicles and diesel vehicles), electric vehicles, hybrid electric vehicles, motorcycles, bicycles, and personal mobilities, moving bodies having various shapes and traveling on roads (e.g., robots), and servers providing various types of information such as information terminal devices including smartphones and the like, for example.

### REFERENCE SIGNS LIST

10 Information providing system
20, 20a Mobile device
21 Input unit
22 Display unit
23 Position information acquisition unit
24, 51 Communication unit
25 Control unit
26 Voice output unit
27 In-vehicle state detection unit
28 Out-vehicle information detection unit
29 Vehicle state detection unit
50 Information processing device
52 Route search unit
53 Information database (DB) unit

1. An information processing device comprising:
an acquisition unit that acquires a predetermined condition input by a user; and
a route search unit that acquires a moving plan including a via-point and a destination, and stop-by place candidates based on the moving plan on the basis of a moving plan search request including the predetermined condition acquired by the acquisition unit, and outputs the moving plan and the stop-by place candidates,
wherein the moving plan is a plan considering a time consumed by the user at least at the via-point.

2. The information processing device according to claim 1, wherein the predetermined condition is any one of items concerning the user, i.e., a moving purpose, preference, gender, age, number of using persons, use time zone, destination, budget, and date and time by which arrival at the destination is necessary.

3. The information processing device according to claim 1, wherein the moving plan is information regarding a route along which a moving body travels, and a date and time on which the moving body travels.

4. The information processing device according to claim 3, wherein the route search unit acquires stop-by information regarding actual traveling of the moving body, and updates the stop-by place candidates on the basis of the acquired stop-by information.

5. The information processing device according to claim 3,
wherein the moving plan search request includes information indicating a situation in the moving body, and
the route search unit selects the stop-by place candidates on the basis of the acquired information indicating the situation in the moving body.

6. The information processing device according to claim 1, wherein the route search unit acquires related person information indicating a person related to the user, and sets the stop-by place candidates on the basis of the related person information.

7. The information processing device according to claim 1, wherein the route search unit displays, together with the moving plan, the stop-by place candidates as positions in a stop-by order of the via-point and the destination in the moving plan.

8. The information processing device according to claim 1, wherein the route search unit acquires the moving plan that passes through the stop-by place candidates in a descending order of priority on the basis of priority set in advance for each of the stop-by place candidates.

9. The information processing device according to claim 1, wherein the route search unit also outputs a reason for recommending each of the stop-by place candidates.

10. The information processing device according to claim 1,
wherein the moving plan search request includes reproduced music information indicating music being reproduced in a moving body boarded by the user that uses the moving plan acquired by the route search unit, and
the route search unit selects the stop-by place candidates on the basis of the reproduced music information.

11. The information processing device according to claim 1,
wherein the route search unit performs control to display the moving plan and the stop-by place candidates on a display unit, and
display of the moving plan is controlled such that information regarding the via-point and the destination is displayed in time series in accordance with an estimated arrival time of each of the via-point and the destination, and that a time consumed by the user at least at the via-point is also displayed.

12. The information processing device according to claim 1, wherein the route search unit performs moving plan search using information that indicates a time consumed by the user at each of the stop-by place candidates and is acquired on the basis of the stop-by place candidates to acquire the moving plan.

13. The information processing device according to claim 1, wherein the route search unit acquires the moving plan that passes near a predetermined facility for each predetermined moving distance.

14. The information processing device according to claim 1, wherein the route search unit acquires the moving plan by search of the moving plan in consideration of congestion state of each of the stop-by place candidates.

15. The information processing device according to claim 1,
wherein the moving plan search request includes information indicating a situation in a moving body boarded by the user that uses the moving plan acquired by the route search unit, and
the route search unit changes the moving plan on the basis of the acquired information indicating the situation in the moving body.

16. The information processing device according to claim 1,
wherein the moving plan search request includes service information possessed by the user that uses the moving plan acquired by the route search unit, and
in the route search unit, a stop-by place for which the service information is available is included in the stop-by place candidate.

17. The information processing device according to claim 1, further comprising
a storage unit that stores the moving plan in a reusable manner,
wherein the route search unit enables the user that uses the moving plan acquired by the route search unit to use the moving plan recorded in the storage unit.

18. An information processing method comprising:
acquiring, by using an acquisition unit, a predetermined condition input by a user; and
acquiring, by using a route search unit, a moving plan that includes a via-point and a destination, and considers a time consumed by the user at least at the via-point on the basis of a moving plan search request including the predetermined condition acquired by the acquisition unit, and stop-by place candidates based on the moving plan, and outputting the moving plan and the stop-by place candidates.

19. A mobile device comprising:
a communication unit that transmits a moving plan search request including a predetermined condition input by a user to an information processing device, and receives a moving plan including a via-point and a destination acquired by the information processing device in response to transmission of the moving plan search request, and stop-by place candidates based on the moving plan;
an input unit through which the predetermined condition is input; and
an information presenting unit that presents the moving plan and the stop-by place candidates received by the communication unit.

20. The mobile device according to claim 19,
wherein the input unit includes a voice input unit,
the information presenting unit includes a display unit or a voice output unit, and
a control unit is further provided to cause the input unit and the information presenting unit to select a stop-by place from the stop-by place candidates, change the selected stop-by place, or change the moving plan in an interactive manner.
